(19) United States
(12) Patent Application Publication
(10) Pub. No.: US 2026/0359639 A1
(43) Pub. Date: Nov. 12, 2026

(54) COMPUTING SYSTEMS AND METHODS FOR QUANTIFYING UNCERTAINTY IN AN LLM-BASED SYSTEM OUTPUT USING BAYESIAN INFERENCE

(71) Applicant: The Toronto-Dominion Bank, Toronto (CA)

(72) Inventors: Brendan Leigh ROSS, Toronto (CA); Jesse Cole CRESSWELL, Toronto (CA); Yi SUI, Newmarket (CA); Noël VOUITSIS, Markham (CA); Gabriel LOAIZA GANEM, Toronto (CA); Ji XIN, Toronto (CA); Kin Kwan LEUNG, Toronto (CA); Zhaoyan LIU, Toronto (CA); Atiyeh ASHARI GHOMI, Toronto (CA); Jiapeng WU, Toronto (CA); Maksims VOLKOVS, Toronto (CA)

(21) Appl. No.: 19/202,604

(22) Filed: May 8, 2025

(51) Int. Cl. G06N 3/084; G06F 16/334; G06N 3/0475

(52) U.S. Cl. CPC G06N 3/084; G06F 16/3346; G06N 3/0475

(57) ABSTRACT

Computing systems and methods for quantifying uncertainty in a large language model (LLM)-based system using Bayesian inference. The LLM-based system is configured to receive an input and generate an output using one or more LLM calls. The LLM-based system comprises a set of one or more textual parameters, such as, but not limited to, system prompts used in the one or more LLM calls. The methods comprise sampling from a posterior probability distribution of the set of one or more textual parameters given a dataset so as to generate a plurality of sample sets of the one or more textual parameters; and using the plurality of sample sets of the one or more textual parameters to quantify the uncertainty in an output of the LLM-based system.

### TECHNICAL FIELD

The disclosed example embodiments relate to computer-implemented methods and systems for quantifying uncertainty in an LLM-based system using Bayesian inference.

### BACKGROUND

Large language models (LLMs) are sophisticated artificial intelligence (AI) models trained on vast amounts of text data. They are designed to understand and generate human-like text. LLMs, such as, but not limited to, GPT (Generative Pre-trained Transformer), use deep learning techniques to analyze the relationships between words and phrases, which allows them to generate meaningful responses, predict text, and even perform tasks like summarizing or translating content. Currently LLMs are used in many different applications across various industries.

LLMs are designed to predict the next word in a sequence based on patterns they have learned from very large datasets. However, LLMs don't have an understanding of truth, context, or real-world verification, instead they rely on statistical relationships between words. This may result in an LLM hallucinating, meaning that the LLM can generate an output that seems plausible but is actually false or completely fabricated. Accordingly, for the output of an LLM to be trusted it is desirable to be able to quantify the uncertainty in the output.

### SUMMARY

The following summary is intended to introduce the reader to various aspects of the detailed description, but not to define or delimit any invention.

A first aspect provides a computing system for quantifying uncertainty in a large language model (LLM)-based system that is configured to receive an input and generate an output via one or more LLM calls, the LLM-based system comprising a set of one or more textual parameters, the computing system comprising: a memory, a communication interface, and at least one processor operatively coupled to the memory and the communication interface; the at least one processor configured to: sample from a posterior probability distribution of the set of one or more textual parameters given a dataset so as to generate a plurality of sample sets of the one or more textual parameters; and use the plurality of sample sets of the one or more textual parameters to quantify uncertainty in an output of the LLM-based system.

Sampling from the posterior probability distribution of the set of one or more textual parameters given the dataset so as to generate the plurality of sample sets of the one or more textual parameters comprises: generating a plurality of candidate sample sets of the one or more textual parameters by using a set of LLMs to iteratively evaluate a performance of the LLM-based system using a candidate sample set of the one or more textual parameters on the dataset, generate feedback on the set of one or more textual parameters based on the evaluation, and generate a new candidate sample set of the one or more textual parameters based on the feedback for use in a next iteration; and selecting the plurality of sample sets from the candidate sample sets of the one or more textual parameters.

The dataset comprises a plurality of input-output pairs, and sampling from the posterior probability distribution of the set of one or more textual parameters given the dataset comprises: (a) receiving a candidate sample set of the one or more textual parameters and identifying the candidate sample set as a current candidate sample set; (b) for each input-output pair of a set of input-output pairs of the dataset: generating an output of the LLM-based system for the input in the input-output pair using the current candidate sample set, using an LLM to generate an evaluation of the output of the LLM-based system based on the output in the input-output pair, and using a set of one or more LLMs to generate, based on the evaluation, textual feedback on the current candidate sample set, and (c) using a set of one or more LLMs to generate a new candidate sample set of the one or more textual parameters based on the textual feedback for the set of input-output pairs of the dataset; (d) iteratively repeating (b) and (c), wherein the new candidate sample set in an iteration is identified as the current sample set for a subsequent iteration; and (e) selecting the plurality of sample sets from the candidate sample sets of the one or more textual parameters.

Steps (a) to (e) may implement a Metropolis Hastings sampling method.

Selecting the plurality of sample sets from the candidate sample sets of one or more textual parameters comprises generating, for each candidate sample set of one or more textual parameters, an acceptance probability and determining whether to select a candidate sample set as a sample set based on the acceptance probability for that candidate sample set.

The LLM-based system may comprise a final LLM that is configured to generate the LLM-based system output for the input in the input-output pair, and generating the acceptance probability for a candidate sample set of the one or more textual parameters may comprise generating a likelihood for the output of the LLM-based system for the input in the input-output pair given the candidate sample set of the one or more textual parameters based on logits of the final LLM.

Generating the acceptance probability for a candidate sample set of the one or more textual parameters may comprise generating a probability assigned to the candidate sample set of the one or more textual parameters based on a set of prior beliefs.

Generating the probability assigned to the candidate sample set of the one or more textual parameters based on the set of prior beliefs may comprise instructing an LLM to evaluate the candidate sample set of the one or more textual parameters based on the set of prior beliefs and using logits of the LLM to determine the probability.

Sampling from the posterior probability distribution of the set of one or more textual parameters given the dataset may further comprise: using an LLM to generate a parameter evaluation of the current candidate sample set of the one or more textual parameters based on prior knowledge, and using a set of one or more LLMs to generate, based on the parameter evaluation, second textual feedback on the current candidate sample set of the one or more textual parameters; wherein the new candidate sample set of the one or more textual parameters is generated based on the textual feedback for the set of input-output pairs of the dataset and the second textual feedback.

The set of input-output pairs of the dataset may comprise all of the input-output pairs in the dataset.

The set of input-output pairs of the dataset may comprise only a subset of the input-output pairs in the dataset.

Selecting the plurality of sample sets from the candidate sample sets of the one or more textual parameters may comprise selecting all of the candidate sample sets as the sample sets.

Using the set of one or more LLMs to generate, based on the evaluation, textual feedback on the current candidate sample set may comprise backpropagating the evaluation to the set of one or more textual parameters using the set of one or more LLMs to generate a textual gradient of the evaluation with respect to the current candidate sample set.

At least one of the one or more textual parameters may comprise a prompt used in an LLM call of the one or more LLM calls.

The LLM-based system may be a retrieval augmented generation system, and the one or more textual parameters may comprise a system prompt used in an LLM call of the one or more LLM calls.

Using the plurality of sample sets of the one or more textual parameters to quantify the uncertainty in an output of the LLM-based system may comprise: for each of the plurality of sample sets of the one or more textual parameters, generating a different version of the LLM-based system that uses that sample set of the one or more textual parameters; generating, for a same input, an output from each different version of the LLM-based system; and generating an uncertainty metric based on a diversity in the outputs generated from the different versions of the LLM-based system.

A second aspect provides a method for quantifying uncertainty in a large language model (LLM)-based system that is configured to receive an input and generate an output via one or more LLM calls, the LLM-based system comprising a set of one or more textual parameters, the method executed in a computing environment comprising at least one processor, a communication interface, and memory, and the method comprising: sampling from a posterior probability distribution of the set of one or more textual parameters given a dataset so as to generate a plurality of sample sets of the one or more textual parameters; and using the plurality of sample sets of the one or more textual parameters to quantify uncertainty in an output of the LLM-based system.

Sampling from the posterior probability distribution of the set of one or more textual parameters given the dataset so as to generate the plurality of sample sets of the one or more textual parameters may comprise: generating a plurality of candidate sample sets of the one or more textual parameters by using a set of LLMs to iteratively evaluate a performance of the LLM-based system using a candidate sample set of the one or more textual parameters on the dataset, generate feedback on the set of one or more textual parameters based on the evaluation, and generate a new candidate sample set of the one or more textual parameters based on the feedback for use in a next iteration; and selecting the plurality of sample sets from the candidate sample sets of the one or more textual parameters.

The dataset may comprise a plurality of input-output pairs, and sampling from the posterior probability distribution of the set of one or more textual parameters given the dataset may comprise: (a) receiving a candidate sample set of the one or more textual parameters and identifying the candidate sample set as a current candidate sample set; (b) for each input-output pair of a set of input-output pairs of the dataset: generating an output of the LLM-based system for the input in the input-output pair using the current candidate sample set, using an LLM to generate an evaluation of the output of the LLM-based system based on the output in the input-output pair, and using a set of one or more LLMs to generate, based on the evaluation, textual feedback on the current candidate sample set, and (c) using a set of one or more LLMs to generate a new candidate sample set of the one or more textual parameters based on the textual feedback for the set of input-output pairs of the dataset; (d) iteratively repeating (b) and (c), wherein the new candidate sample set in an iteration is identified as the current sample set for a subsequent iteration; and (e) selecting the plurality of sample sets from the candidate sample sets of the one or more textual parameters.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a schematic diagram of an example LLM-based system with a single LLM call;

FIG. 2 is a schematic diagram of an example compound LLM-based system (CLBS) with a plurality of LLM calls;

FIG. 3 is a schematic diagram of an example retrieval augmented generation (RAG) system;

FIG. 4 is a block diagram of an example system for quantifying the uncertainty in an LLM-based system output using Bayesian inference;

FIG. 5 is a block diagram of an example implementation of the cloud-based computing cluster of FIG. 4 configured to quantify the uncertainty in an LLM-based system output using Bayesian inference;

FIG. 6 is a schematic diagram illustrating backpropagation of a Loss in the output of a neural network to numerical parameters of the neural network;

FIG. 7 is a schematic diagram illustrating backpropagation of a Loss in the output of the example CLBS of FIG. 2 to the textual parameters of the example CLBS;

FIG. 8 is a block diagram of an example implementation of the sample generation module of FIG. 5;

FIG. 9 is a block diagram of an example implementation of the uncertainty generation module of FIG. 5;

FIG. 10 is a flow diagram of an example method for quantifying the uncertainty in an LLM-based system output using Bayesian inference;

FIG. 11 is a flow diagram of an example method of sampling the posterior probability distribution of the set of textual parameters given a dataset;

FIG. 12 is a flow diagram of an example method of quantifying the uncertainty in the output of an LLM-based system using a plurality of sample sets of textual parameters; and

FIG. 13 is a block diagram of an example computer.

### DETAILED DESCRIPTION

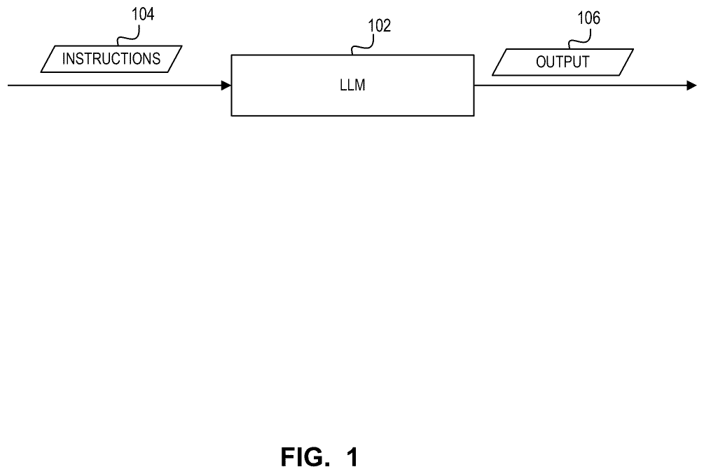

The standard way to use an LLM, which is illustrated in FIG. 1, is to provide a single LLM 102 textual instructions 104 (e.g., a set of one or more prompt) and the LLM 102 generates an output 106 in response to the textual instructions 104. However, it is starting to be more common to see agentic or compound LLM systems in which an LLM is combined with one or more other LLMs, AI models, tools, search engines, calculators etc. Such systems may be referred to herein as compound LLM-based systems (CLBS). A CLBS may have, for example, multiple LLMs chained together such that the output of one LLM becomes the input to the next LLM; or an LLM and another tool, search engine or calculator chained together such that the output of the LLM feeds into the tool, search engine or calculator.

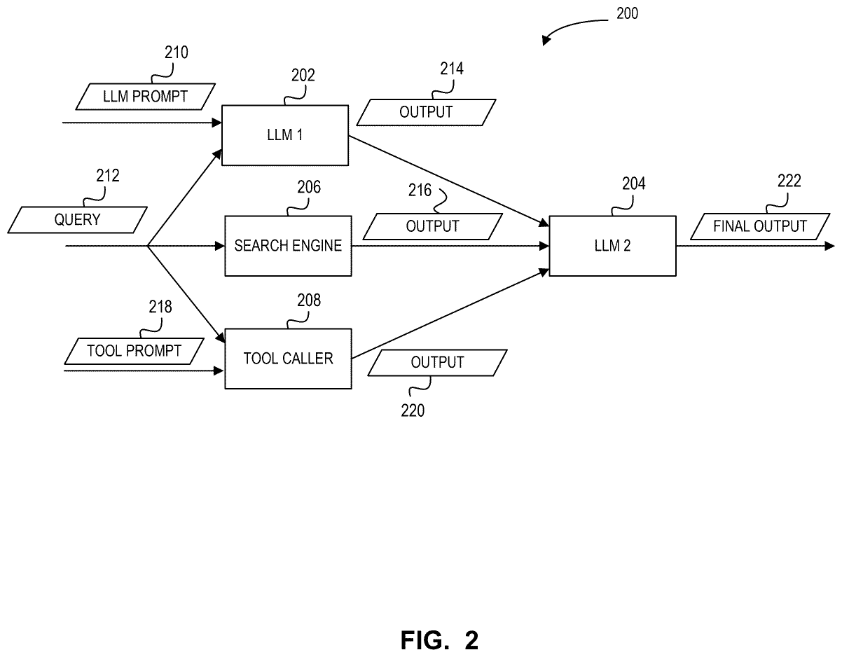

An example CLBS 200 is shown in FIG. 2. In this example, the CLBS comprises two LLMs 202, 204, a search engine 206 and a tool caller 208. The first LLM 202 is configured to receive an LLM prompt 210 and a query 212 and generate a textual output 214 (which may also be referred to herein as the response). The search engine 206 is configured to receive the query 212 and generate an output 216 based thereon. The tool caller 208 is configured to receive a tool prompt 218 and the query 212 and generate an output 220 based thereon. The second LLM 204 is configured to receive the outputs 214, 216, 220 generated by the first LLM 202, search engine 206 and tool caller 208 and generate a final output 222 based thereon.

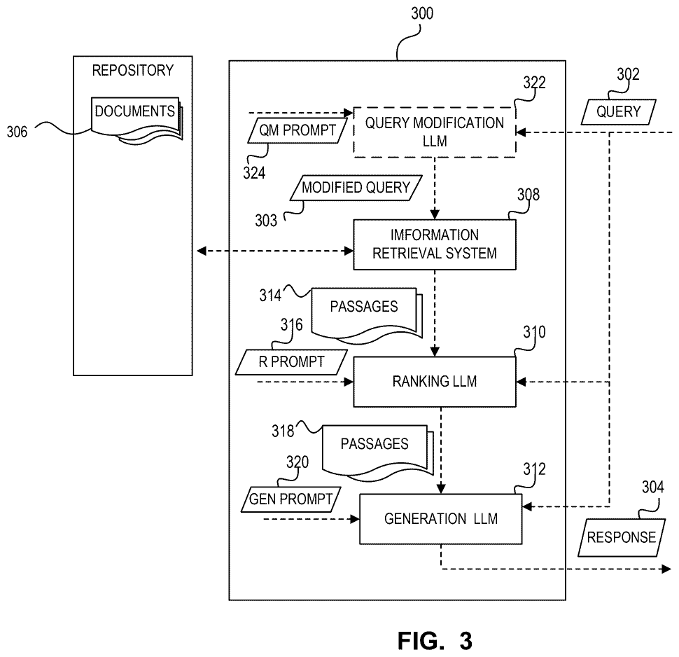

Another example CLBS, is a RAG (retrieval augmented generation) system, such as that illustrated in FIG. 3. Specifically, there are many applications where it may be useful to be able to generate a response to a user query based on a private or non-public corpus of documents (e.g., documents internal to an enterprise). For example, an enterprise may have a set of agents that receive enquiries from customers about products and services offered by the enterprise. While information that resolves the customer's query can generally be found in the enterprise's internal and/or external documents it may be cumbersome for an agent (or another enterprise employee) to locate information relevant to a customer's query in the internal and/or external documents. It is desirable to generate an answer to the customer's query in a more efficient and automated way.

With the emergence of large language models (LLMs) and their ability to generate understand and generate human-like text based on patterns they recognize, LLMs seem well suited to automatically generate responses to queries. However, while LLMs are trained on a vast amount of data from various fields, if the query relates to information that is not known to the LLM (e.g., information that did not form part of the LLM's training dataset)—because, for example, the information relates to a specific domain or to an enterprise's internal knowledge base—the LLM may not be able to provide an accurate answer to the query. Accordingly, a technique referred to as retrieval augmented generation (RAG) has been developed.

Specifically, in a RAG system, such as the RAG system 300 of FIG. 3, a query is first sent to an information retrieval (IR) system to retrieve information from an external knowledge base (external to the data used to train the LLM) which comprises, for example, documents etc. related to a specific domain and/or an enterprise's internal documents etc.; then the retrieved information and the original query are provided to an LLM along with instructions to generate a response to the query based on the provided information. In this way the external knowledge base is used to enhance the LLM's output without having to re-train the LLM.

The example RAG system 300 of FIG. 3 is configured to receive a query 302 and generate a response 304 based on a set of documents 306. The example RAG system 300 comprises an information retrieval system 308, a ranking LLM 310 and a generation LLM 312. The information retrieval system 308 is configured to receive the query 302 (or a modified query 303) and obtain a set of passages 314 from the set of documents that are relevant to the query 302, wherein a passage may be all or portion of a document. The ranking LLM 310 is configured to receive the set of passages 314, the query 302 and a ranking “R” prompt 316 which causes the ranking LLM 310 to re-rank the set of passages based on their relevance to the query 302. A subset of the passages 318 is then selected based on the ranking. The generation LLM 312 is configured to receive the subset of passages 318, the query 302 and a generation “GEN” prompt 320 which causes the generation LLM 312 to generate a response 304 to the query 302 based on the subset of passages 318.

In some cases, the RAG system 300 may also comprise a query modification LLM 322 that is configured to receive the query 302 and a query modification “QM” prompt 324 which causes the query modification LLM 322 to perform query expansion on the original query 302 to generate a modified query 303. In these cases, it is the modified query 303 that is provided to the information retrieval system 308 instead of the original query 302. Query expansion is a technique in which a query is changed or modified to include additional information to improve the quality of the query.

As described above, LLMs are designed to predict the next word in a sequence based on pattern they have learned from very large datasets. However, LLMs don't have an understanding of truth, context, or real-world verification, instead they rely on statistical relationships between words. This may result in an LLM hallucinating, meaning that the LLM can generate an output that seems plausible but is actually false or completed fabricated. Accordingly, for the output of an LLM (or CLBS) to be trusted it is desirable to be able to quantify the uncertainty in the output. There currently lacks a principled way to do this for CLBS.

Accordingly, described herein are systems and methods for quantifying the uncertainty in the output of an LLM-based system, such as, but not limited to, a CLBS, by performing Bayesian inference on the textual parameters (e.g., system prompts) of the LLM-based system. Specifically, the uncertainty of the LLM-based system is determined by: sampling the posterior probability distribution of the set of textual parameters (e.g., system prompts) of the LLM-based system given a dataset to generate a plurality of sample sets of textual parameters; then the plurality of sample sets of textual parameters are used to quantify the uncertainty in the output of the LLM-based system. In some cases, the posterior probability distribution of the set of one or more textual parameters given the dataset is sampled using the Metropolis Hastings algorithm (or a pseudo Metropolis Hastings algorithm) wherein TextGrad is used to implement the proposal distribution, q(θ′|θⱼ), of the Metropolis Hastings algorithm (i.e., q(θ′|θⱼ) is a TextGrad update to the set of one or more textual parameters, θ). In some cases, using the plurality of sample sets of textual parameters to quantify the uncertainty in the output of the LLM-based system may comprise generating, for each sample set of one or more textual parameters, an output of the LLM-based system using that sample set of textual parameters for an input, and determining the uncertainty in the output of the LLM-based system based on the variability in the outputs.

### Bayesian Inference and Machine Learning Models

In machine learning there is generally a machine learning model (e.g., a neural network) that is defined by a set of numerical parameters (e.g., weights, biases). The parameters of the model are selected to perform a specific task.

The machine learning model can be viewed as a probability model. For example, let there be a machine learning model, f_{θ}, whose parameters are expressed by a vector θ. If the machine learning model is configured to perform classification, then probability model can be expressed by equation (1), where, given an input x∈ [symbol] ^{p}, the machine learning model f_{θ} assigns a probability to each possible output y∈Υ using the set of parameters θ. For classification, Υ is the set of classes and p(y|x, θ) is a categorical distribution given by the SoftMax outputs f_{θ}(x) from the machine learning model.

p(y|x,θ)=Categorical(f_{θ}(x)) (1)

One method of learning the parameters (e.g., weights, biases) of such a model is maximum likelihood estimation (MLE). MLE is performed using an i.i.d. (independent and identically distributed) training dataset D={(x₁,y₁) . . . (xₙ,yₙ)}. The likelihood of having drawn the dataset D given a set of parameters θ can be expressed by equation (2).

p(D|θ)=Πᵢp((xᵢ,yᵢ)|θ)=Πᵢp(yᵢ|xᵢ,θ)p(xᵢ) (2)

MLE involves identifying the parameters, θ_{MLE}, that maximize the likelihood (i.e., equation (2)) as set out in equation (3).

$$\begin{matrix}{θ}_{MLE} = arg {max}_{θ} p ( D \vert θ ) \\ = arg {max}_{θ} log ( p ( D \vert θ ) ) \\ = arg {max}_{θ} ( log ( p ( {x}_{i} ) ) + {\sum }_{i} log ( p ( {y}_{i} \vert {x}_{i} , θ ) ) ) \\ = arg {max}_{θ} ( {\sum }_{i} log ( p ( {y}_{i} \vert {x}_{i} , θ ) ) )\end{matrix} \qquad ( 3 )$$

θ_{MLE} may be identified by, for example, gradient descent (e.g., backpropagation) where it is assumed that p(D|θ) is differentiable in θ.

Another method of learning the parameters (e.g., weights, biases) of such a model is maximum a posteriori (MAP) estimation which is based on Bayesian inference. Bayesian inference is way of updating beliefs about something based on new evidence or information. Bayesian inference starts with a prior distribution that is meant to encode previous assumptions, and derives the posterior distribution p(A|B) (i.e., the probability of A given B, i.e., after B is observed) from the prior distribution, p(A), (i.e., the prior knowledge), the likelihood, p(B|A), (the probably of observing B given A) and evidence, p(B), using Bayes theorem, which is expressed by equation (4).

$$p ( A \vert B ) = \frac{p ( B \vert A ) p ( A )}{p ( B )} \qquad ( 4 )$$

In the context of identifying model parameters, it is the posterior distribution of the parameters, θ, given the training data, D, that is relevant (i.e., p(θ|D)). The posterior distribution of the parameters given the training data can be expressed by equation (5). In this example, p(θ) is the prior, p(D|θ) is the likelihood and p(D) is the evidence.

$$\begin{matrix}p ( θ \vert D ) = \frac{p ( D \vert θ ) p ( θ )}{p ( D )} \\ = \frac{p ( θ ) {\prod }_{i} p ( {y}_{i} \vert {x}_{i} , θ ) p ( {x}_{i} )}{{\int }_{θ} p ( θ ) {\prod }_{i} p ( {y}_{i} \vert {x}_{i} , θ ) p ( {x}_{i} ) d θ} \\ = \frac{p ( θ ) {\prod }_{i} p ( {y}_{i} \vert {x}_{i} , θ )}{{\int }_{θ} p ( θ ) {\prod }_{i} p ( {y}_{i} \vert {x}_{i} , θ ) d θ}\end{matrix} \qquad ( 5 )$$

MAP estimation involves selecting the set of parameters, θ_{MAP}, that maximizes the posterior (i.e., equation (5)), as set out in equation (6).

$$\begin{matrix}{θ}_{MAP} = arg {max}_{θ} ( p ( θ \vert D ) ) \\ = arg {max}_{θ} ( \frac{p ( D \vert θ ) p ( θ )}{p ( D )} ) \\ = arg {max}_{θ} ( p ( D \vert θ ) p ( θ ) ) \\ = arg {max}_{θ} ( log ( p ( D \vert θ ) ) + log ( p ( θ ) ) ) \\ = arg {max}_{θ} ( {\sum }_{i} log ( p ( {y}_{i} \vert {x}_{i} , θ ) ) + log ( p ( θ ) ) )\end{matrix} \qquad ( 6 )$$

MAP estimation can be thought of as MLE with regularisation introduced by the prior (p(θ)). It can be seen that MAP estimation amounts to maximizing the likelihood multiplied by the prior knowledge. If having zero prior knowledge is encoded as uniformity (i.e., p(θ)∝1), then when there is no prior knowledge MAP estimation reduces to MLE.

However, both MLE and MAP estimation both select a single set of parameters θ. This can result in instabilities since both the likelihood and the posterior can spike to infinity in places that are not representative of good modelling solutions. Thus, there may be multiple choices for the parameters θ which may be suitable. It would be desirable to be able to incorporate each of them along with the level of certainty (p(θ|D)) about each one.

The uncertainty about a set of parameters θ is considered epistemic uncertainty and can be equated to the Bayesian posterior (i.e., p(θ|D)). The uncertainty arising due to inherent randomness in the model itself is considered aleatoric uncertainty and can be modelled, for a given choice of θ, as p(y|x,θ). The uncertainty in classifying a new datapoint x (that is independent of the dataset D) in light of the dataset D which takes into account both types of uncertainty can be expressed in equation (7) where E is the expected value.

$$\begin{matrix}p ( y \vert x , D ) = {\int }_{θ} p ( y , θ \vert x , D ) d θ \\ = {\int }_{θ} {\underbrace{p ( y \vert x , θ )}}_{aleatoric} {\underbrace{p ( θ \vert D )}}_{epistemic} d θ \\ = {E}_{θ ∼ p ( θ \vert D )} [ p ( y \vert x , θ ) ]\end{matrix} \qquad ( 7 )$$

This means that the predictive distribution of y that incorporates all the uncertainty about θ can be generated by sampling some parameter choices independently from p(BID) and evaluating the model on x with each θ.

### Bayesian Inference and CLBS

A similar Bayesian approach can be used to determine the uncertainty in the output of an LLM-based system, such as, but not limited to, a CLBS, by treating the textual parameters of an LLM-based system in the same manner as the numerical parameters of a machine learning model (e.g., a neural network)—i.e., by performing Bayesian inference on the textual parameters of the LLM-based system.

Specifically, an LLM-based system, such as, but not limited to, a CLBS, can be represented by the probability model of equation (1) (i.e., p(y|x, θ)=Categorical (f_{θ}(x))) where θ represents the textual parameters of the LLM-based system, f_{θ} is the LLM-based model with a specific set of textual parameters, x is the input to the LLM-based system, y is the output of the LLM-based system, and p(y|x, θ) is a distribution over all possible outputs from the LLM-based system. For example, for the example CLBS 200 of FIG. 2, f_{θ} is the CLBS 200 itself, the textual parameters θ are the LLM prompt 210 and the tool prompt 218, the input x is the query, and the output y is the final output 222. As noted above, an LLM-based system is configured to generate a textual output in response to an input, using at least one LLM call. An LLM-based system thus comprises at least one LLM, but may also comprise other components, such as, but not limited to, one or more other LLMs, one or more databases, one or more search engines, one or more application programming interfaces (APIs), and/or one or more humans which may be called to generate information which is used in generating the final textual output.

The textual parameters of an LLM-based system may comprise text, such as, but not limited to, system prompts that control the operation of the LLM-based system. It is noted that the textual parameters θ, even when they comprise a single system prompt, can be incredibly complex. Specifically, system prompts can be many thousands of characters long, containing both general instructions (“You are a helpful chatbot answering questions about x in tone y for audience z.”; “Answer only using information from the provided context.”) and specific instructions designed to handle corner cases (“Do not mention x, as x is out of scope.”; “Before answering any queries about y, ask for clarification about z.”) There is naturally a great deal of uncertainty about the correct style and content for system prompts. Accordingly, it is desirable to take this uncertainty and variability into account.

In the same manner that the predictive distribution of a numerical output of a machine learning model (e.g., neural network) that incorporates all the uncertainty about a set of numerical parameters (e.g., weights and biases) can be generated by sampling some parameter choices independently from the posterior distribution and evaluating the model with those parameter choices; the predictive distribution of a textual output of an LLM-based system that incorporates all the uncertainty about a set of textual parameters (e.g. system prompt(s)) can be generated by sampling some parameter choices independently from the posterior distribution and evaluating the LLM-based system with those parameter choices. In other words, the predictive distribution of the textual output of an LLM-based system may be implemented by performing Bayesian inference on the textual parameters.

### Example System

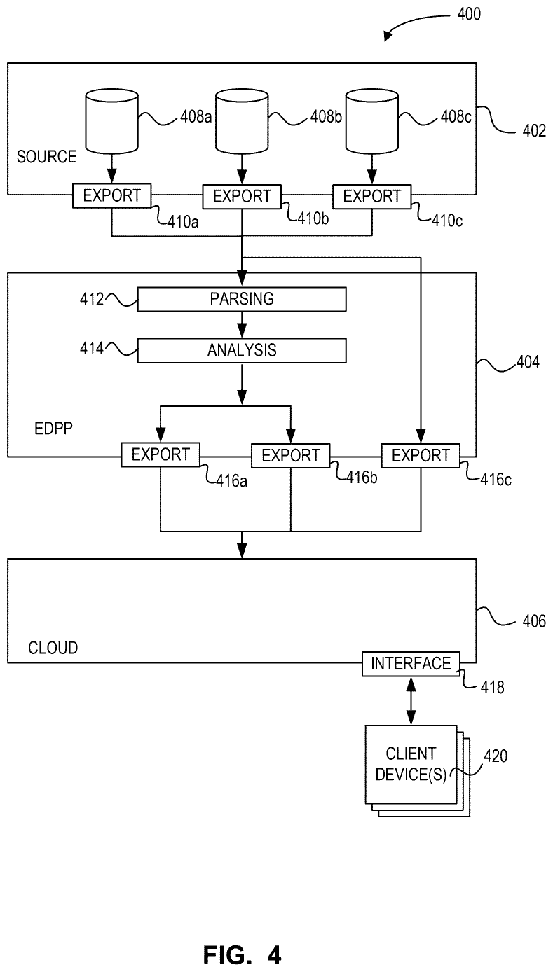

Reference is now made to FIG. 4, which illustrates a block diagram of an example computing system 400 for quantifying the uncertainty in an LLM-based system output using Bayesian inference. Computing system 400 comprises a source database system 402, an enterprise data provisioning platform (EDPP) 404 operatively coupled to the source database system 402, and a cloud-based computing cluster 406 that is operatively coupled to the EDPP 404.

Source database system 402 has one or more databases, of which three are shown for illustrative purposes: database 408a, database 408b and database 408c. One or more of the databases of the source database system 402 may contain confidential information that is subject to restrictions on export. One or more export modules 410a, 410b, 410c may periodically (e.g., daily, weekly, monthly, etc.) export data from the databases 408a, 408b, 408c to the EDPP 404. In some instances, the data is exported on an ad hoc basis.

EDPP 404 receives source data exported by the export modules 410a, 410b, 410c of source database system 402, processes it and exports the processed data to an application database within the cloud-based computing cluster 406. For example, a parsing module 412 of EDPP 404 may perform extract, transform and load (ETL) operations on the received source data.

In many environments, access to the EDPP may be restricted to relatively few users, such as administrative users. However, with appropriate access permissions, data relevant to a document or group of documents (e.g., a client document) may be exported via reporting and analysis module 414 or an export module 416a, 416b, 416c. In particular, parsed data can then be processed and transmitted to the cloud-based computing cluster 406 by a reporting and analysis module 414. Alternatively, one or more export modules 416a, 416b, 416c can export the parsed data to the cloud-based computing cluster 406.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. In some cases, to comply with such restrictions, one or more module of EDPP 404 may “de-risk” data tables that contain confidential data prior to transmission to cloud-based computing cluster 406. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The cloud-based computer cluster 406 is configured to quantify the uncertainty in an LLM-based system output using Bayesian inference. The cloud-based computing cluster 406 includes an interface 418, which facilitates data communication with one or more client devices 420.

In some environments, the EDPP may be omitted.

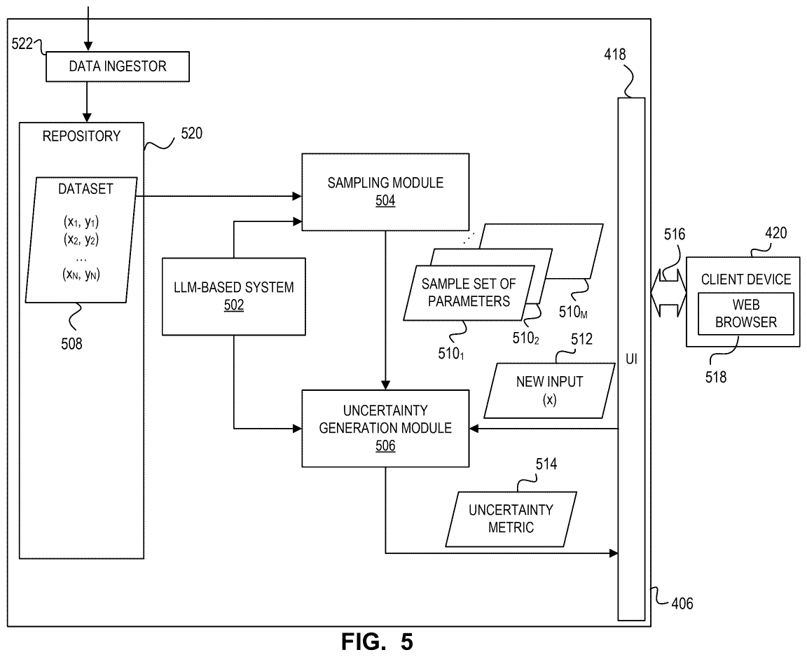

Reference is now made to FIG. 5, which illustrates an example implementation of the cloud-based computing cluster 406 of FIG. 4. As described above, the cloud-based computing cluster is configured to quantify the uncertainty in an LLM-based system 502 output using Bayesian inference. In the example shown in FIG. 5, the cloud-based computing cluster 406 comprises a sampling module 504 and an uncertainty generation module 506.

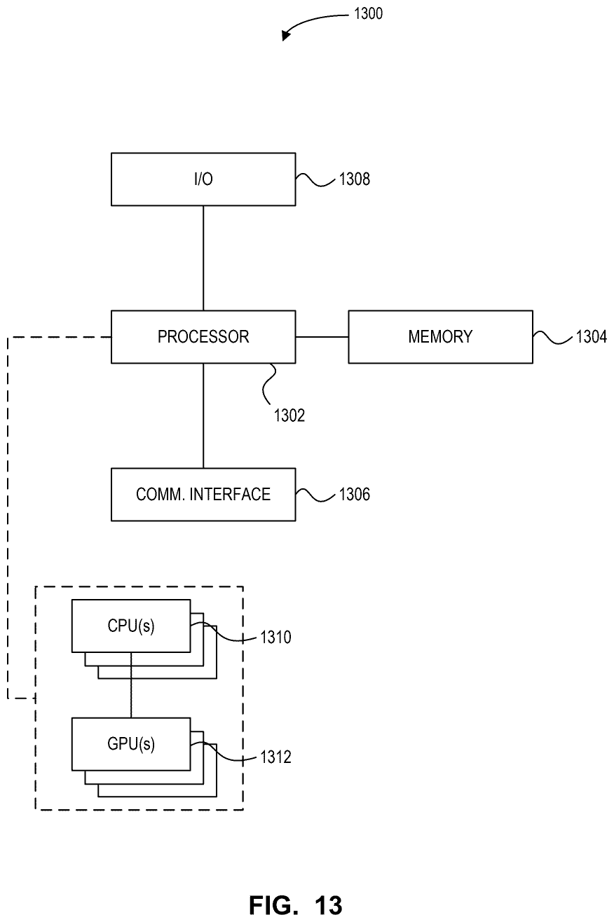

In some cases, one or more components of the cloud-based computing cluster 406 may be implemented by one or more computers within the cloud-based computing cluster, such as, but not limited to, computer 1300 described below with respect to FIG. 13. In some cases, one or more components of the cloud-based computing cluster 406 may be implemented as virtual machines within the cloud-based computing cluster.

An LLM-based system 502 is a system that receives an input and generates a textual output in response to the input using one or more LLM calls. An LLM-based system thus comprises at least one LLM, but may also comprise other components, such as, but not limited to, one or more other LLMs, one or more databases, one or more search engines, one or more application programming interfaces (APIs), and/or one or more humans which may be called to generate information which is used in generating the final textual output. Example LLM-based systems are shown in FIGS. 1, 2 and 3.

An LLM-based system 502 comprises a set of one or more textual parameters. Textual parameters include any text that is received by or output by a component of the LLM-based system. Textual parameters include configurable text that controls the operation of the LLM-based system, such as, but not limited to, system prompts (e.g., LLM prompt 210 and tool prompt 218 in the example CLBS 200 of FIG. 2). The set of one or more textual parameters of an LLM-based system are denoted by the vector θ.

The sampling module 504 is configured to perform Bayesian inference (i.e., compute the posterior distribution) on the set of one or more textual parameters, θ, of the LLM-based system 502. Specifically, the sampling module 504 is configured to sample from the posterior probability distribution of the set of one or more textual parameters θ given a dataset D 508 (i.e., sample from p(θ|D)) to generate a plurality of sample sets of the one or more textual parameters 510₁, 510₂ . . . 510_{M} (i.e., a plurality of choices for the set of one or more textual parameters). In the examples described herein, the dataset comprises a plurality of input-output pairs (i.e., D={(x₁,y₁), (x₂,y₂) . . . (x_{N},y_{N})}. For example, where the LLM-based system 502 is configured to generate a response to a query, the dataset D may comprise a plurality of question-response pairs. Each sample set of one or more textual parameters 510₁, 510₂ . . . 510_{M} comprises sample text for each of the one or more textual parameters. In other examples, the dataset may comprise other labelled data.

However, sampling from p(θ|D) is difficult due to the complexity thereof. Specifically, as described above, p(θ|D) is calculated as shown in equation (5), which is reproduced below as equation (8).

$$p ( θ \vert D ) = \frac{p ( θ ) {\prod }_{i} p ( {y}_{i} \vert {x}_{i} , θ )}{{\int }_{θ} p ( θ ) {\prod }_{i} p ( {y}_{i} \vert {x}_{i} , θ ) d θ} \qquad ( 8 )$$

Specifically, it is intractable to compute the denominator of equation (8). However, the numerator, denoted p*(θ) (i.e., p*(θ)=p(θ)Πᵢp(yᵢ|xᵢ,θ)), can be computed. That said, p*(θ) is still an unnormalized distribution (i.e., one whose density is known only up to a constant), making it difficult to sample from. Specifically, the main difficulty in sampling from an unnormalized distribution is that standard direct sampling techniques cannot be used since information about the total probably mass is lacking, which is required to calculate proper probabilities for each possible outcome. This makes it impossible to select samples proportionally to their true likelihoods without additional calculations or an approximation method.

However, there are a number of known techniques for sampling an unnormalized distribution, such as, but not limited to, variational inference and Monte Carlo methods. Monte Carlo (MC) methods are a class of techniques for randomly sampling a probability distribution. One example MC method, which may be used to sample from p(θ|D) is the Metropolis-Hastings (MH) method.

The MH method is a Markov Chain Monte Carlo (MCMC) method for obtaining a sequence of random samples (θ₁, θ₂, θ₃, . . . θₜ) from a probability distribution from which direct sampling is difficult. New samples are added to a sequence in two steps: (1) a new sample (which may be referred to herein as a candidate sample) is proposed based on the previous sample; and (2) the new sample is either added to the sequence or rejected based on the value of the probability distribution at that point. If enough samples are added to the sequence the samples will represent the probability distribution. The method used to propose new candidates is characterized by the probability distribution q(θ′|θ) of a new proposed sample θ′ given the previous sample θ. q(θ′|θ) may be referred to as the proposal density, proposal function, or jumping distribution.

Specifically, in accordance with the MH method the sequence of samples (θ₁, θ₂, θ₃, . . . θₜ) whose limiting distribution equals p*(θ) may be generated by the following steps, where the method is started with θⱼ=θ₀:
1. Propose a candidate θ′ from q(θ′|θ)
2. Compute the acceptance probability, α, in accordance with equation (9).

$$α = \frac{{p}^{*} ( {θ}^{′} ) q ( {θ}_{j} \vert {θ}^{′} )}{{p}^{*} ( {θ}_{j} ) q ( {θ}^{′} \vert {θ}_{j} )} = \frac{q ( {θ}_{j} \vert {θ}^{′} ) p ( {θ}^{′} ) {\prod }_{i} p ( {y}_{i} \vert {x}_{i} , {θ}^{′} )}{q ( {θ}^{′} \vert {θ}_{j} ) p ( {θ}_{j} ) {\prod }_{i} p ( {y}_{i} \vert {x}_{i} , {θ}_{j} )} \qquad ( 9 )$$

3. Sample u~Uniform (0,1). Then set θⱼ₊₁ as set out in equation (10).

$${θ}_{j + 1} = \{ \begin{matrix}{θ}_{j} if u > α \\ {θ}^{′} if u \leq α\end{matrix} \qquad ( 10 )$$

Steps 1-3 are repeated until θₜ has been added to the sequence. If t is chosen large enough then θₜ~p(θ|D). The basis for this method is that a proposed θ′~q(θ′|θ) is more likely to be accepted if its density p*(θ′) is high relevant to θⱼ. Accordingly, this process is analogous to “stochastically” climbing up to higher regions of p*(θ′).

While technically any q(θ′|θ) may be used, ideally q(θ′|θ) makes a small change to θ that will land in an area such that p*(θ′) is high. Accordingly, it is preferable for q(θ′|θ) to generate better and better choices for the textual parameters.

In some cases, q(θ′|θ) may be implemented manually. For example, if the set of one or more textual parameters comprises a single system prompt. The LLM-based system may be instructed, via an initial system prompt, to generate an output for a test input. A prompt engineer may then modify the initial system prompt based on the output (e.g., compared to the ground truth or desired output) to improve the output generated by the LLM-based system. For example, the prompt engineer may modify the system prompt to add a definition of a domain-specific term that it appears the LLM didn't understand. In some cases, the system prompt may be modified after using the initial system prompt to generate outputs for a plurality of test inputs (forming the dataset D). The process may then be repeated with the modified system prompt. However, this iterative process is both labour and time intensive.

Recently there has been a body of work related to using LLMs to provide textual feedback to improve a parameter or variable of an artificial intelligence (AI) system, such as an LLM-based system. One such example of this work is TextGrad which is described in Yuksekgonul et al. “TextGrad: Automatic “Differentiation” via Text”, arXiv preprint arXiv:2406.07496, 2024, which is herein incorporated by reference in its entirety.

TextGrad is a framework for performing automatic “differentiation” via text. More particularly, in the TextGrad framework textual feedback generated by LLMs is backpropagated through an AI system (such as an LLM-based system) to improve textual parameters thereof in a similar manner that backpropagation and automatic differentiation can be used to optimize the numerical parameters of a neural network for a specific task.

Specifically, to train a neural network using backpropagation and numerical gradients, a forward pass of the neural network is performed with a set of inputs to generate an output. A loss function is then evaluated which compares the generated output to a desired output to generate a loss. The loss is then backpropagated through the network of the neural network to compute the numerical gradient of the loss with respect to each weight via the chain rule (this is referred to as a backward pass of the neural network). The gradient of the loss with respect to each weight indicates a direction and magnitude to adjust the weight to minimize the loss function. Each weight is then adjusted accordingly (e.g., in accordance with the gradient descent algorithm).

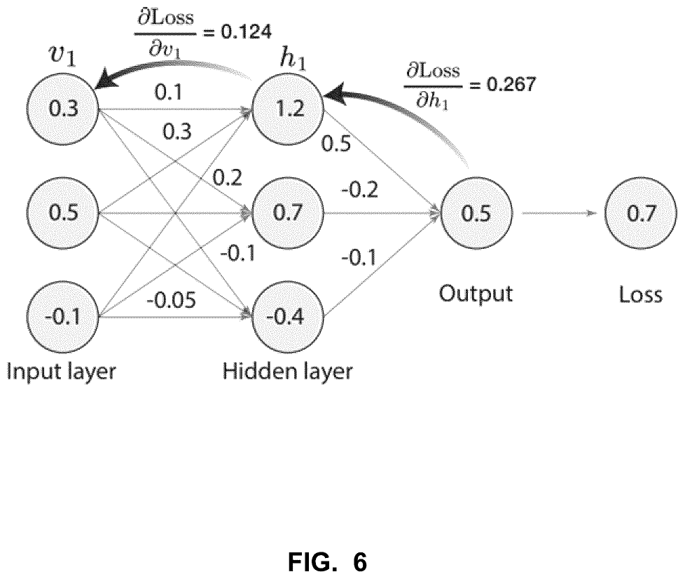

The same concept can be applied to any input to the neural network to determine how to change that input to improve the loss. For example, as shown in FIG. 6, which reproduces FIG. 1a of Yuksekgonul et al., the loss (Loss) can be back-propagated through the neural network to generate the gradient of the loss with respect to the input v₁

$$( i . e . , \frac{\partial Loss}{\partial {v}_{1}} ) )$$

via the chain rule by first computing the gradient of the loss with respect to the output of the first layer h₁

$$( i . e . , \frac{\partial Loss}{\partial {h}_{1}} ) .$$

The TextGrad framework applies this concept to AI systems, such as LLM-based systems, to improve one or more textual parameters thereof by, instead of computing numerical gradients, computing textual gradients and backpropagating the textual gradients through the AI system. A textual gradient is described as information and interpretable natural language criticism to the variables, describing how a variable should be changed to improve the system.

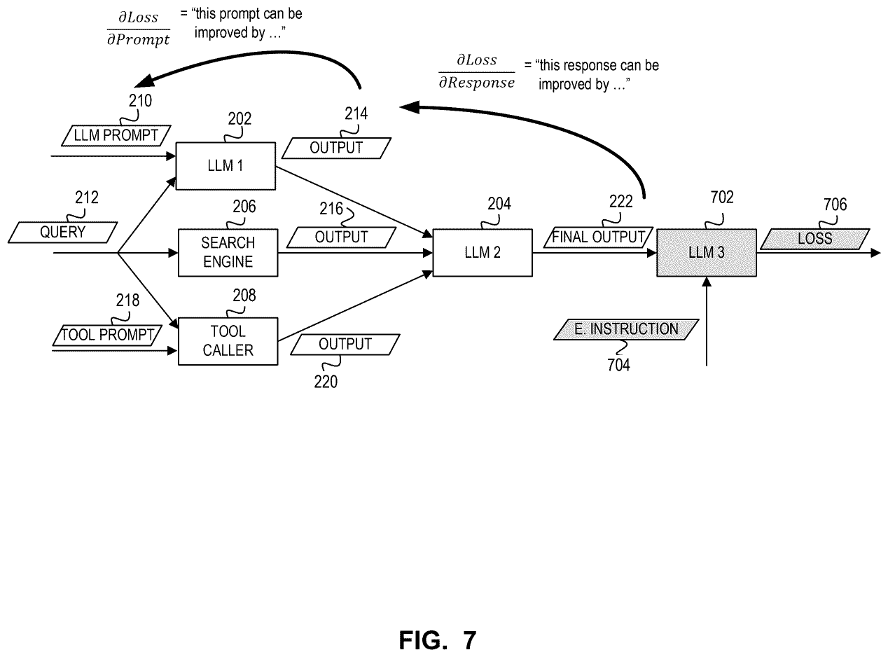

F or example, FIG. 7, illustrates how TextGrad may be used to improve the LLM prompt 210 of the example CLBS 200 of FIG. 2. Specifically, as described above, in the forward pass, the first LLM 202 receives an LLM prompt 210 and a query 212 and generates a response to the query (i.e., output 214). That response (i.e., output 214) is fed to the second LLM 204 along with other data (i.e., outputs 216 and 220) and the second LLM 204 generates a final output 222 for the CLBS 200. In the TextGrad framework, to improve the LLM prompt 210, another LLM 702, is used in conjunction with an evaluation “E” instruction 704, to evaluate the final output 222 with respect to, for example, the ground truth output to generate a loss 706. A textual gradient of the loss 706 with respect to the initial prompt is generated via backpropagation. Specifically, an LLM (not shown) is used to compute the textual gradient of the loss with respect to the response (i.e., the output 214 of the first LLM 202)

$$( i . e . , \frac{\partial Loss}{\partial Response} ) .$$

The textual gradient may, for example, provide textual comments on how to improve the response to improve the loss. Then an LLM (not shown) is used to compute the textual gradient of the loss with respect to the initial LLM prompt

$$( i . e . , \frac{\partial Loss}{\partial Prompt} )$$

based on the textual gradient of the loss with respect to the output of the first LLM

$$( i . e . , based on \frac{\partial Loss}{\partial Response} ) .$$

This textual gradient may, for example, provide textual comments on how to improve the initial LLM prompt to improve the response, which will improve the loss. The initial LLM prompt may then be modified (e.g., via an LLM) based on the feedback. This process may be performed iteratively.

In some cases, TextGrad may be used to implement q(θ′|θ) of the Metropolis Hastings algorithm. Specifically, q(θ′|θ) may be a TextGrad update to the set of textual parameters (θ). In some cases, since the objective is to increase p*(θ), the target loss for a TextGrad update may be as shown in equation (11).

$$Loss = log {p}^{*} ( θ ) = log p ( θ ) + {\sum }_{i} log p ( {y}_{i} \vert {x}_{i} , θ ) \qquad ( 11 )$$

However, TextGrad uses a textual loss. Thus, the elements of equation (11) may be replaced with textual surrogates that contain the same conceptual meaning. For example, log p(θ) may be replaced with a textual loss P(θ) centered around φ, where, as described in more detail below, φ is a metaprompt that is provided to an LLM describing how to generate θ based on a set of prior beliefs. For example, P(θ) may be, the output of an LLM in response to the prompt “Provide feedback on how well this prompt {θ} satisfies this description {φ}.” log p(yᵢ|xᵢ,θ) may be replaced with a textual loss Lᵢ(θ) describing how well an output y matches the annotated example yᵢ. For example, Lᵢ(θ) may be the output of an LLM in response to “Critique how well the content of this candidate answer {y} matches this ground truth answer {yᵢ}.”

As noted above, in addition to iteratively generating candidate samples, the MH method comprises generating the acceptance probability, α, of each candidate sample as set out in equation (9). This comprises computing three values for θ′ (i.e., q(θⱼ|θ′); p(θ′); Πᵢp(yᵢ|xᵢ,θ′)) and three values for θⱼ (q(θ′|θ); p(θⱼ); flip(yᵢ|xᵢ, θⱼ)).

p(yᵢ|xᵢ,θ) is the probability assigned to yᵢ given xᵢ and θ. Where the final output of the LLM-based system is generated by a final LLM, p(yᵢ|xᵢ,θ) can be the probability assigned by the final LLM to yᵢ. Where the final LLM is open-source this can be determined from the SoftMax outputs of the final LLM. p(θ) is the probability assigned to θ in accordance with prior beliefs. Different θ can be assigned priorities in any suitable manner. In one example, θ~LLM(φ) where, as described above, φ is a metaprompt that is provided to an LLM describing how to generate θ based on a set of prior belief. Where that LLM is open-source p(θ) can be determined from the SoftMax outputs of that LLM. Where TextGrad is used to implement q(θ′|θⱼ) (i.e., q(θ′|θⱼ) is a TextGrad update to the set of textual parameters) and the modified or updated set of one or more textual parameters is generated by an LLM (which may be referred to herein as an optimizer LLM) then this may be generated from the SoftMax outputs of that LLM (if an open-source LLM).

Once the acceptance probability is generated for a candidate sample then the sampling module 504 determines, based on the acceptance probability (e.g., in accordance with equation (10)), whether the candidate sample is to be used as a sample—i.e., whether it is to be added to the sequence.

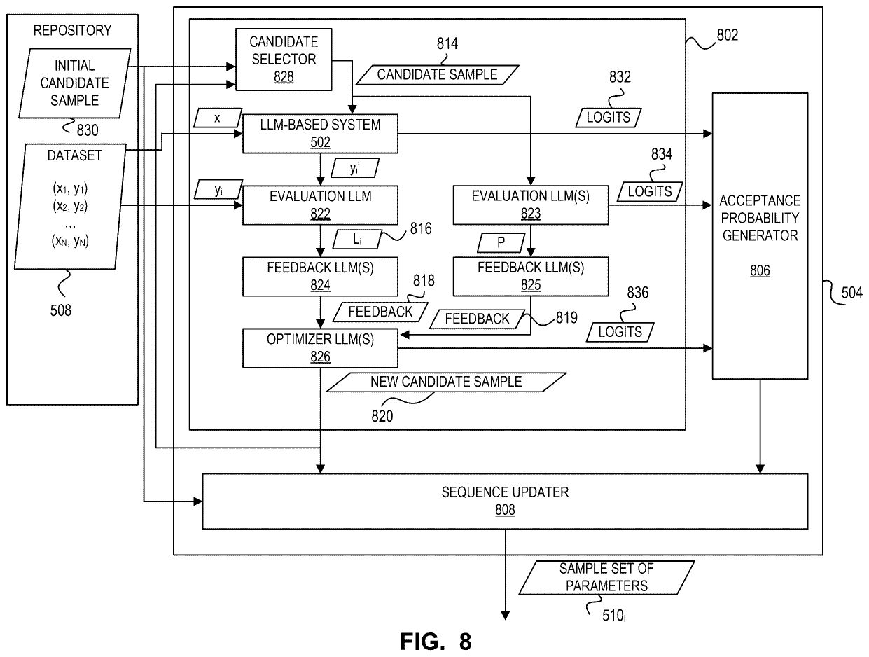

An example implementation of the sampling module 504 that is configured to sample the posterior probability distribution in accordance with the MH method, wherein TextGrad is used to implement the proposal distribution of MH, is described below with respect to FIG. 8. Each candidate sample set of one or more textual parameters that is added to the sequence becomes a sample set of one or more textual parameters 510₁, 510₂ . . . 510_{M}.

In other examples, instead of, or in addition to using TextGrad to generate the candidate samples, the candidate sample sets may be generated by randomly removing sentences from the textual parameters.

The uncertainty generation module 506 is configured to quantify the uncertainty in the LLM-based system's output in response to a new input x 512 based on the generated sample sets of the one or more textual parameters 510₁, 510₂ . . . 510_{M}.

In some cases, the uncertainty generation module 506 is configured to quantify the uncertainty in the LLM-based system 502 output from the sample sets of one or more textual parameters 510₁, 510₂ . . . 510_{M} by: (i) for each sample set of one or more textual parameters 510₁, 510₂ . . . 510_{M}, generating a version of the LLM-based system that uses that sample set of one or more textual parameters; (ii) generating an output, yᵢ*, from each version of the LLM-based system, for a new input 512; and (iii) generating an uncertainty metric 514 based on the diversity in the outputs. There are a number of uncertainty metrics which could be used.

One example uncertainty metric, referred to as a UCon score, is described in Wang et al. “ConU: Conformal Uncertainty in Large Language Models with Correctness Coverage Guarantees”, arXiv preprint arXiv:2407.00499, 2024, which is incorporated herein in its entirety. To generate the UCon score, it is assumed there are M different versions of the LLM-based system numbered from 1 to M, and the output of the m^{th} version of the LLM-based system is denoted ŷₘ. The semantics in the M outputs are then clustered into K non-repeated semantics numbered from 1 to K. The number of outputs in the k^{th} cluster is denoted Vₖ. Since each output can only belong to one cluster

$${\sum }_{k = 1}^{K} \frac{{V}_{k}}{M} .$$

Any output in the k^{th} cluster is denoted ŷₖ.

In this method the frequency, [symbol] , of the k^{th} semantic is used as a proxy for reliability—i.e.,

$$ℱ ( {\hat{y}}_{k} ) = \frac{{V}_{k}}{M} .$$

To measure the uncertainty in the LLM-based system, the largest sematic cluster is used as the most trustworthy semantic (i.e., the cluster that has the greatest number of outputs). One output in that cluster is selected as the representative output and denoted ŷₘₛₜ. The uncertainty U in the LLM-based system is then computed as set out in equation (12) where [symbol] (ŷₘₛₜ) refers to the frequency of the semantic that ŷₘₛₜ belongs to, and S(⋅,⋅) measures the semantic similarity between two outputs using a cross-encoder model. It is noted that [symbol] (ŷₖ) is used to augment the persuasiveness of the similarity score associated with ŷₖ.

$$U ( {\{ {\hat{y}}_{m} \}}_{m - 1}^{M} \vert x ) = 1 - λ \cdot ℱ ( {\hat{y}}_{mst} ) - ( 1 - λ ) \cdot \frac{1}{K} {\sum }_{k = 1}^{K} S ( {\hat{y}}_{mst} , {\hat{y}}_{k} ) ℱ ( {\hat{y}}_{k} ) \qquad ( 12 )$$

Even though the reference semantic (i.e., the sematic to which the most outputs belong) may not necessarily be the correct one, the degree of the LLM-based system's uncertainty can be measured by calculating the confidence level of that semantic as well as the deviation between it and the other semantics.

Another example metric which may be used as the uncertainty metric is the claim scores for conformal factuality described in Mohri et al., “Language models with conformal factuality guarantees”, arXiv preprint arXiv:2402.10978, 2024 which is incorporated herein in its entirety.

Some metrics which may be used to measure the accuracy of the uncertainty quantification include, but are not limited to, abstention accuracy or AUC; expected calibration error; or out-of-distribution (OOD) detection (which is a similar task to abstention but measured on OOD inputs).

In some cases, the new input x 512 may be received from a user via, for example a user interface 418. In some cases, the new input x 512 is provided by a client device 420 that is connected over a data communication link 516 to the user interface 418. For example, a user may provide the new input x 512 via a web browser 518 or some other application that operates on the client device 420. In particular, when the user accesses a certain web page via the web browser 518, they may be provided with a text field or the like where the user can enter the new input x 512. Similarly, in some cases, the uncertainty metric may be provided to a user's client device 420 via the user interface 418.

In some cases, the dataset D 508 may be stored in a repository 520 of the cloud-based computing cluster 406. A repository 520 is any device or mechanism for storing digital data. In some cases, the dataset D 508 may be received from the source database system 402 and/or the EDPP 404 via, for example, a data ingestor 522.

### Example Sampling Module

Reference is now made to FIG. 8, which illustrates an example implementation of the sampling module 504 of FIG. 5. In the example implementation shown in FIG. 8, the sampling module 504 is configured to sample the posterior probability distribution (p(θ|D)) using the Metropolis Hastings algorithm wherein TextGrad is used to implement the proposal distribution, q(θ′|θⱼ), of the Metropolis Hastings algorithm (i.e., q(θ′|θⱼ) is a TextGrad update to the set of one or more textual parameters, θ).

The example sampling module 504 of FIG. 8 comprises a candidate sample generator 802, an acceptance probability generator 806 and a sequence updater 808.

In some cases, one or more components of the sampling module 504 may be implemented by one or more computers, such as not limited to, computer 1300 described below with respect to FIG. 13. In some cases, one or more components of the sampling module 504 may be implemented as virtual machines.

The candidate sample generator 802 is configured to iteratively generate a plurality of candidate samples for the set of one or more textual parameters θ of an LLM-based system 502 using a dataset D 508 and TextGrad. Specifically, the candidate sample generator 802 is configured to iteratively generate updates to the set of one or more textual parameters using the TextGrad method based on the performance of the LLM-based system on the dataset D 508.

As described above, for TextGrad to implement the first step of the Metropolis Hastings algorithm, ideally TextGrad makes a small change to the set of one or more textual parameters that will land in an area such that p*(θ) is high. Accordingly, preferably the target loss fora TextGrad update is as set out in equation (11) (i.e., Loss=log p*(θ)=log p(θ)+Σᵢ log p(yᵢ|xᵢ,θ)).

However, as described above, TextGrad uses a textual loss. Thus, the elements of equation (11) may be replaced with textual surrogates that contain the same conceptual meaning. For example, log p(θ) may be replaced with a textual loss P(θ) centered around φ, where, as described above, φ is a metaprompt that is provided to an LLM describing how to generate θ based on a set of prior beliefs. log p(yᵢ|xᵢ,θ) may be replaced with a textual loss Lᵢ(θ) describing how well an output y matches the annotated example yᵢ.

Accordingly, in each iteration, the candidate sample generator 802 is configured to: (a) receive a candidate sample set of the one or more textual parameters 814; (b) for each input, xᵢ, in the dataset D 508: generate an output yᵢ′ using the LLM-based system 502 and the candidate sample set of the one or more textual parameters 814, generate Lᵢ(θ) 816 for that generated output yᵢ′ that indicates the quality of the generated output based on the corresponding output yᵢ in the dataset D 508, and generate textual feedback 818 on how to improve the set of one or more textual parameters based on Lᵢ(θ) 816; (c) generate P(θ) that indicates how well the candidate sample set of the one or more textual parameters 814 matches prior beliefs, and generate textual feedback 819 on how to improve the set of one or more textual parameters based on P(θ); and (d) generate a new candidate sample set of one or more textual parameters 820 for the one or more textual parameters based on the feedback 818 and 819. The new candidate sample set of one or more textual parameters 820 generated in an iteration becomes the starting candidate sample set of one or more textual parameters 814 in the next iteration. Each new candidate sample set of one or more textual parameters 820 is a candidate sample in the Metropolis Hastings algorithm. Accordingly, the candidate sample generator 802 is configured to perform step 1 of the Metropolis Hastings algorithm described above.

In the example shown in FIG. 8, the candidate sample generator 802 comprises the LLM-based system 502, a first evaluation LLM 822, a second evaluation LLM 823, a first set of one or more feedback LLMs 824, a second set of one or more feedback LLMs 825, and one or more optimizer LLMs 826. In the example of FIG. 8, the evaluation LLMs 822, 823, feedback LLMs 824, 825, and optimizer LLM(s) 826 are shown as different LLMs, however, in other examples, two or more of the LLMs 822, 823, 824, 825, 826 may be combined. In other words, in other examples, a single LLM may perform the functions described as being performed by two or more of an evaluation LLM 822, 823 a feedback LLM 824, 825 and an optimizer LLM 826. For example, a single LLM may perform the evaluation LLM 822 function and a feedback LLM 824 function.

The candidate sample generator 802 is configured to receive, for each iteration, a candidate sample set of one or more textual parameters 814. For example, where the LLM-based system is the example CLBS 200 of FIG. 2 with two textual parameters—the LLM prompt 210 and the tool prompt 218—the candidate sample set of the one or more textual parameters 814 may comprise an LLM prompt 210 and a tool prompt 218. In some cases, the candidate sample set of the one or more textual parameters 814 for an iteration may be provided via a candidate selector 828 which is configured to, in the first iteration, provide an initial candidate sample set of the one or more textual parameters 830, and in subsequent iterations, provide the new candidate sample set of the one or more textual parameters 820 generated in the previous iteration. The initial candidate sample set of the one or more textual parameters 830 may be selected or generated in any suitable manner.

Once the candidate sample set of the one or more textual parameters (θ) 814 for an iteration has been received, the candidate sample generator 802 is configured to: (1) for each input, xᵢ, in the dataset D 508, compute Lᵢ(θ) 816 and generate feedback 818 on θ based thereon; and (2) generate P(θ) and generate feedback 819 on θ based thereon.

The candidate sample generator 802 may implement (1) by generating, using the LLM-based system 502 configured with the received candidate sample set of one or more textual parameters 814, an output

$${y}_{i}^{′}$$

for each input, xᵢ, in the dataset D 508. For example, where the LLM-based system 502 is the CLBS 200 of FIG. 2, a final output 222 is generated for each (query, final output) pair in the dataset.

The evaluation LLM 822 is then used to evaluate the output

$${y}_{i}^{′}$$

generated by the LLM-based system 502 with respect to the corresponding output in the dataset D 508 (i.e., the evaluation LLM 822 is used to generate Lᵢ(θ) 816). Specifically, the evaluation LLM 822 may be provided the output

$${y}_{i}^{′}$$

generated by the LLM-based system 502, the corresponding output yᵢ in the dataset D 508 (which may be referred to as the reference output) and an evaluation prompt (not shown) which causes the evaluation LLM 822 to evaluate the output

$${y}_{i}^{′}$$

generated by the LLM-based system 502 with respect to the corresponding output yᵢ and generate an evaluation (Lᵢ(θ) 816) based thereon. The evaluation (Lᵢ(θ) 816) indicates the quality of the output

$${y}_{i}^{′}$$

generated by the LLM-based system 502 with respect to the corresponding output yᵢ in the dataset D 508.

Any suitable evaluation prompt may be used. An example evaluation prompt for evaluating the output of an LLM-based system which is configured to receive a query and generate a response is shown below. This is just an example and in other examples, other evaluation prompts may be used.
Critique how well the content of this candidate answer {y′ᵢ} matches this ground truth answer {y}.

LLMs are a class of machine learning models that have been trained on massive amounts of data so that they can understand and generate natural language. The evaluation LLM 822 may be implemented by any LLM that can compare a textual output to a reference output. In some cases, the evaluation LLM 822 may be implemented by a Microsoft Azure™ Open AI LLM (e.g., a GPT-4o, GPT-4 Turbo, GPT-4, or GPT-3.5 Turbo model).

Once an evaluation (Lᵢ(θ) 816) has been generated for a generated output

$${y}_{i}^{′} ,$$

the first set of one or more feedback LLMs 824 are used to generate textual feedback 818 on each textual parameter in the set of one or more textual parameters based on the evaluation (Lᵢ(θ) 816). The feedback 818 for a textual parameter may be in the form of textual suggestions on how the textual parameter may be improved and/or textual criticisms of the textual parameter.

In some cases, in accordance with the TextGrad framework, the textual feedback 818 fora textual parameter may be considered to represent the textual gradient of the evaluation (Lᵢ(θ) 816) with respect to that textual parameter. Similar to how a numerical gradient for a neural network can be computed via backpropagation, a textual gradient can also be generated via backpropagation. Specifically, the evaluation (Lᵢ(θ) 816) can be backpropagated through the LLM-based system.

For example, in the example CLBS 200 of FIG. 2, to improve the LLM prompt 210 with respect to the evaluation (Lᵢ(θ) 816), the textual gradient of the evaluation (Lᵢ(θ) 816) with respect to the LLM prompt 210

$$( i . e . , \frac{\partial {L}_{i} ( θ )}{\partial LLMprompt} )$$

is computed. Using the chain rule, the textual gradient of the evaluation (Lᵢ(θ) 816) with respect to the LLM prompt 210 can be expressed by equation (13) where

$$\frac{\partial {L}_{i} ( θ )}{\partial response}$$

represents the textual gradient of the evaluation (L₁(I) 816) with respect to the output 214 of the first LLM 202. The textual gradient of the evaluation (Lᵢ(θ) 816) with respect to the output 214 of the first LLM can be expressed by equation (14) where

$$\frac{\partial {L}_{i} ( θ )}{\partial {y}_{i}^{′}}$$

represents the textual gradient of the evaluation (Lᵢ(θ) 816) with respect to the final output 222

$$( i . e . , {y}_{i}^{′} ) . \qquad ( 13 )$$

$$\frac{\partial {L}_{i} ( θ )}{\partial LLMprompt} = \frac{\partial response}{\partial LLMprompt} ◦ \frac{\partial {L}_{i} ( θ )}{\partial response}$$

$$\frac{\partial {L}_{i} ( θ )}{\partial response} = \frac{\partial {y}_{i}^{′}}{\partial response} ◦ \frac{\partial {L}_{i} ( θ )}{\partial {y}_{i}^{′}} \qquad ( 14 )$$

Thus, the textual gradient of the evaluation (Lᵢ(θ) 816) with respect to the LLM prompt 210

$$( \frac{\partial {L}_{i} ( θ )}{\partial LLMprompt} )$$

can be generated by (a) generating the textual gradient of the evaluation (Lᵢ(θ) 816) with respect to the final output 222

$$( i . e . {y}_{i}^{′} ) ( i . e . , \frac{\partial {L}_{i} ( θ )}{{y}_{i}^{′}} ) ;$$

(b) generating the textual gradient of the evaluation (Lᵢ(θ) 816) with respect to the output 214 of the first LLM 202

$$( \frac{\partial {L}_{i} ( θ )}{\partial response} )$$

based on the textual gradient of the evaluation (Lᵢ(θ) 816) with respect to the final output 222

$$( {y}_{i}^{′} ) ( i . e . , \frac{\partial {L}_{i} ( θ )}{\partial {y}_{i}^{′}} ) ;$$

and (b) generating the textual gradient of the evaluation (Lᵢ(θ) 816) with respect to the LLM prompt 210

$$( \frac{\partial {L}_{i} ( θ )}{\partial LLMprompt} )$$

based on the textual gradient of the evaluation (Lᵢ(θ) 816) with respect to the output 214 of the first LLM 202

$$( i . e . , \frac{\partial {L}_{i} ( θ )}{\partial response} ) .$$

In other words, first textual feedback on how to improve the final response to improve the evaluation (Lᵢ(θ) 816)

$$( i . e . , \frac{\partial {L}_{i} ( θ )}{\partial {y}_{i}^{′}} )$$

is generated, then second textual feedback on how to improve the out put 214 of the first LLM 202 to improve the evaluation (Lᵢ(θ) 816)

$$( i . e . , \frac{\partial {L}_{i} ( θ )}{\partial response} )$$

is generated from the first textual feedback, and then third textual feedback on how to improve the LLM prompt 210 to improve the evaluation (Lᵢ(θ) 816)

$$( i . e . , \frac{\partial {L}_{i} ( θ )}{\partial LLMprompt} )$$

is generated from the second textual feedback.

This can be implemented, by using a first feedback LLM (i.e., a first feedback LLM call) to generate the first textual gradient i.e., the textual gradient of the evaluation (Lᵢ(θ) 816) with respect to the final output 222,

$${y}_{i}^{′} , ( i . e . , \frac{\partial {L}_{i} ( θ )}{\partial {y}_{i}^{′}} ) ;$$

using a second feedback LLM (i.e., a second feedback LLM call) to generate the second textual gradient—i.e., the textual gradient of the evaluation (Lᵢ(θ) 816) with respect to the output 214 of the first LLM 202

$$( \frac{\partial {L}_{i} ( θ )}{\partial response} )$$

based on the first textual gradient; and using a third feedback LLM (i.e., a third feedback LLM call) to generate the third textual gradient—i.e., the textual gradient of the evaluation (Lᵢ(θ) 816) with respect to the LLM prompt 210

$$( i . e . \frac{\partial {L}_{i} ( θ )}{\partial LLMprompt} )$$

based on the second textual gradient.

Using a first feedback LLM to generate the first textual gradient—i.e., the textual gradient of the evaluation (Lᵢ(θ) 816) with respect to the final output 222 (i.e.

$$( i . e . \frac{\partial {L}_{i} ( θ )}{\partial {y}_{i}^{′}} )$$

may comprise providing the first feedback LLM, with the inputs and outputs of the evaluation LLM 822 (i.e., the reference output yᵢ, the generated output

$${γ}_{i}^{′} ,$$

the evaluation prompt, and the evaluation (Lᵢ(θ) 816)) and a first feedback prompt which causes the first feedback LLM to provide first textual feedback on how to improve the output

$${y}_{i}^{′}$$

so as to improve the evaluation (Lᵢ(θ) 816). In other words, the first feedback LLM is provided with the conversation with the evaluation LLM 822 and asked to provide feedback on the generated output

$${y}_{i}^{′}$$

based thereon. An example simple first feedback prompt is shown below. Note that the evaluation prompt refers to the query, output and reference output. This is just an example first feedback prompt and other (e.g., more detailed) first feedback prompts may be used.
Here is a conversation with a language model (ML):
Prompt: {evaluation prompt}
Output: {y′i}
Reference output: {yᵢ}
Evaluation: {Lᵢ}
Explain how to improve the output {y′i}.

Using a second feedback LLM to generate the second textual gradient—i.e., the textual gradient of the evaluation (Lᵢ(θ) 816) with respect to the output generated by the first LLM

$$( \frac{\partial {L}_{i} ( θ )}{\partial response} )$$

may comprise providing a second feedback LLM with the inputs and outputs of the second LLM (i.e., a prompt (not shown in the figures), the outputs 214, 216, 220, and the final output), the first textual feedback and a second feedback prompt which causes the second feedback LLM to provide textual feedback on how to improve the response (i.e., output 214) based on the first textual feedback. In other words, the second feedback LLM is provided with the conversation with the second LLM 204, the feedback on how the final output can be improved and is asked to generate feedback on how the response (i.e., output 214) can be improved. An example simple second feedback prompt is shown below. This is just an example and other (e.g., more detailed or complex) second feedback prompts may be used.
Here is a conversation with a language model:
Prompt: {instructions for LLM 2}
Response: {output of LLM 1}
Search Engine Output: {output of search engine}
Tool Output: {output of tool}
LLM 2 Output: {final output}
Here is feedback on how the final output can be improved:
{first feedback}
Explain how to improve the response {output of LLM 1}.

Using a third feedback LLM to generate the third textual gradient—i.e., the textual gradient of the evaluation (Lᵢ(θ) 816) with respect to the LLM prompt 210

$$( \frac{\partial {L}_{i} ( θ )}{\partial LLMprompt} )$$

may comprise providing the third feedback LLM with the inputs and outputs of the first LLM (i.e., the LLM prompt 210, the query 212, and the output 214), the second textual feedback and a third feedback prompt which causes the third feedback LLM to provide textual feedback on how to improve the LLM prompt 210 based on the second textual feedback. In other words, the third feedback LLM is provided with the conversation with the first LLM 202, the feedback on how the output 214 can be improved and is asked to generate feedback on how the LLM prompt 210 can be improved. An example simple third feedback prompt is shown below. This is just an example and other (e.g., more detailed or complex) third feedback prompts may be used.
Here is a conversation with a language model:
Prompt: {LLM prompt}
Query: {query}
Response: {output of LLM 1}
Here is feedback on how the response can be improved:
{second feedback}
Explain how to improve the LLM prompt {LLM prompt}.

As described above, LLMs are a class of machine learning models that have been trained on massive amounts of data so that they can understand and generate natural language. The one or more feedback LLMs 824 may be implemented by any LLM that can provide textual feedback on how to improve a textual parameter. In some cases, the one or more of the feedback LLMs 824 may be implemented by a Microsoft Azure™ Open AI LLM (e.g., a GPT-4o, GPT-4 Turbo, GPT-4, or GPT-3.5 Turbo model).

The candidate sample generator 802 may implement (2) (i.e., generate P(θ)), and generate feedback on θ based thereon) by for each textual parameter, providing the text for that parameter along with an evaluation prompt to an evaluation LLM 823, such as, but not limited to, the prompt shown below, to generate P(θ) 817 that indicates how well the text for that parameter satisfies the prior knowledge where φ represents the prior knowledge. In some cases, φ may vary between parameters.
Provide feedback on how well this parameter {θᵢ} satisfies this description {φᵢ}

Then, providing P(θ) 817 to a feedback LLM 825 along with a feedback prompt that causes the feedback LLM 825 to generate feedback on how to improve the set of one or more textual parameters based on P(θ) 817. As described above, in some cases, generating P(θ) 817 may comprise generating feedback based on the prior separately for each of the one or more textual parameters. In such cases, feedback 819 for each parameter may be generated separately based on the feedback for that parameter based on the prior.

After the feedback 818, 819 has been generated, a new candidate sample set of the one or more textual parameters 820 is generated based on the feedback 818. 819. In some cases, the candidate text for a textual parameter is generated using an LLM, such as the optimizer LLM 826. For example, for each textual parameter, the optimizer LLM 826 may be provided with (1) the current text for that parameter; (2) the feedback 818, 819 for that textual parameter; and (3) an optimizer prompt which instructs the optimizer LLM 826 to generate modified text for that parameter based on the feedback. The following is a simple example optimizer prompt to generate a new LLM prompt 210 based on the feedback on that prompt received from each of the N inputs in the dataset D and based on the feedback 819. However, this is just an example and other (e.g., more complicated and/or sophisticated) optimizer prompts may be used.
Below is the feedback on the LLM prompt {LLM prompt}:
{third feedback 1}
{third feedback 2}
. . .
{third feedback N}
{feedback based on P}
Incorporate the feedback and produce a new LLM prompt.

The new candidate sample for the set of one or more textual parameters 820 is forwarded to the sequence updater 808 which, as described in more detail below determines whether the candidate sample forms part of the set or sequence of samples.

As described above, LLMs are a class of machine learning models that have been trained on massive amounts of data so that they can understand and generate natural language. The optimizer LLM 826 may be implemented by any LLM that can amend a textual parameter based on feedback received on that textual parameter. In some cases, the optimizer LLM 426 may be implemented by a Microsoft Azure™ Open AI LLM (e.g., a GPT-4o, GPT-4 Turbo, GPT-4, or GPT-3.5 Turbo model).

The acceptance probability generator 806 is configured to generate the acceptance probability of each candidate sample set for the one or more textual parameters. In other words, the acceptance probability generator 806 is configured to implement step 2 of the Metropolis Hastings algorithm. As described above, the acceptance probability, α, of each candidate sample may be generated in accordance with equation (9). This comprises computing three values for θ′ (i.e., q(θ|θ′); p(θ′); Πᵢp(y|xᵢ,θ′)) and three values for θⱼ (i.e., q(θ′|θⱼ); p(θⱼ); Πᵢp(yᵢ|xᵢ,θⱼ)).

As described above, p(yᵢ|xᵢ,θ) is the probability assigned to yᵢ given xᵢ and θ. Where the final output of the LLM-based system is generated by a final LLM, p(yᵢ|xᵢ,θ) can be the probability assigned by the final LLM to yᵢ. Where the final LLM is open-source this can be determined from the SoftMax outputs of the final LLM. Accordingly, in the example shown in FIG. 8, the acceptance probability generator is configured to generate, for the candidate sample set of the one or more textual parameters 814 for each iteration, p(yᵢ|xᵢ,θ) for each (xᵢ, yᵢ) in the dataset from the SoftMax output (e.g., logits 832) and generate Πᵢp(yᵢ|xᵢ,θⱼ) therefrom.

p(θ) is the probability assigned to θ in accordance with prior beliefs. Different θ can be assigned priorities in any suitable manner. In one example, shown in FIG. 8, θ~LLM(φ) where φ is a metaprompt that is provided to an LLM describing how to generate θ based on a set of prior beliefs. Where that LLM is open-source p(θ) can be determined from the SoftMax outputs (e.g., logits 834) of that LLM.

Where, as described in the example shown in FIG. 8, TextGrad is used to implement q(θ′|θⱼ) (i.e., q(θ′|θⱼ) is a TextGrad update to the set of textual parameters) and the modified or updated set of one or more textual parameters is generated by an LLM (e.g. optimizer LLM 826) then q(θ′|θⱼ) may be generated from the SoftMax outputs (e.g., logits 836) of that LLM (if an open-source LLM).

In some cases, the acceptance probability generator may generate q(θⱼ|θ′)*p(θ′)*Πᵢp(yᵢ|xᵢ,θ′) for the candidate sample set of one or more textual parameters 814 used in each iteration as described above and then output that to the sequence updater 808 where the sequence updater 808 calculates the final acceptance probability based on which candidate samples are being compared. In other cases, the sequence updater 808 may provide the acceptance probability generator 806 with information indicating which two candidate samples are being compared and the acceptance probability generator 806 generates the acceptance probability based on those two candidate sample and provides this to the sequence updater 808.

The sequence updater 808 is configured to receive the new candidate sample set of the one or more textual parameters 820 generated by the candidate sample generator 802 and, for each received new candidate sample set of the one or more textual parameters 820, determine whether the new candidate sample set of the one or more textual parameters 820 should be added to the sequence of samples (i.e., whether it is to be used as a sample set of parameters 510ᵢ) based on the acceptance probability for that new candidate sample set of the one or more textual parameters 820. In other words, the sequence updater 808 is configured to implement step 3 of the Metropolis Hastings algorithm described above. As described above, the determination of whether a candidate sample set of parameters is to be added to the sequence based on the acceptance probability may be made in accordance with equation (10). As noted above, in some cases, the sequence updater 808 may receive the acceptance probability for a candidate sample from the acceptance probability generator 806. In other cases, the sequence updater 808 may receive information from the acceptance probability generator 806 from which the acceptance probability for a candidate sample can be generated.

While the sampling method implemented by the sampling module 504 of FIG. 8 is effective, and truly Bayesian, it may be time and computationally intensive, depending on the number of (xᵢ, yᵢ) pairs in the dataset D 508. Specifically, the sampling method implemented by the sampling module 504 of FIG. 8 involves, each iteration (i.e., for each candidate sample set of the one or more textual parameters) computing Lᵢ(θ) (and p(yᵢ|xᵢ,θ)) for each (xᵢ, yᵢ) pair in the dataset D 508. The time and computing resources to implement the sampling method may be reduced by, for example, using a mini batch for each iteration. However, in some cases, the three Metropolis Hastings steps described above maybe modified to account for the mini batches. One example modification of the Metropolis Hastings method for use with mini batches is described in Seita et al., “An Efficient Minibatch Acceptance test for Metropolis Hastings”, in Proceedings of the 27^{th} International Joint Conference on Artificial Intelligence, pages 5359-5363, 2018, which is incorporated herein in its entirety, and comprises the following steps:
1. Propose a candidate θ′ from q(θ′|θ)
2. Draw a minibatch of m (xᵢ, yᵢ) pairs from the dataset D.
3. Compute a minibatch estimator Δ* in accordance with equation (15) and sample variance

$${s}_{Δ}^{2}$$

in accordance with equation (16) where b is the number of (xᵢ, yᵢ) pairs in the minibatch.

$${Δ}^{*} = \frac{N}{b} {\sum }_{i = 1}^{b} log \frac{p ( {y}_{i} \vert {x}_{i} , {θ}^{′} )}{p ( {y}_{i} \vert {x}_{i} , {θ}_{j} )} - log ( u \frac{q ( {θ}_{j} \vert {θ}^{′} ) p ( {θ}^{′} )}{q ( {θ}^{′} \vert {θ}_{j} ) p ( {θ}_{j} )} \qquad ( 15 )$$

$${s}_{{Δ}^{*}}^{2} ∝ {‖ {θ}^{′} - {θ}_{j} ‖}_{2}^{2} \qquad ( 16 )$$

4. Estimate moments E[|Λᵢ−Λ|] and E[|Λᵢ−Λ|³] from the sample and error ϵ from Corollary 1, where Λᵢ is expressed in equation (17), Λ is expressed in equation (18), Corollary 1 is expressed by equation (19) and ϵ is the upper bound of Corollary 1.

$${Λ}_{i} = N log \frac{p ( {y}_{i} \vert {x}_{i} , {θ}^{′} )}{p ( {y}_{i} \vert {x}_{i} , {θ}_{j} )} \qquad ( 17 )$$

$$Λ = {\sum }_{i = 1}^{N} log \frac{p ( {y}_{i} \vert {x}_{i} , {θ}^{′} )}{p ( {y}_{i} \vert {x}_{i} , {θ}_{j} )} \qquad ( 18 )$$

$$sup \vert Pr ( {Δ}^{*} < y ) - Φ ( \frac{γ - Δ}{{s}_{{Δ}^{*}}} ) \vert \leq \frac{6.4 E [ {\vert X \vert}^{3} ] + 2 E [ \vert X \vert ]}{\sqrt{b}} \qquad ( 19 )$$

5. While

$${s}_{{Δ}^{*}}^{2} \geq 1$$

or ϵ>δ, draw another m (xᵢ, yᵢ) pairs from the dataset D, update Δ*,

$${s}_{{Δ}^{*}}^{2}$$

and ϵ estimates.
6. Draw

$${X}_{n c} ∼ N ( 0 , 1 - {s}_{{Δ}^{*}}^{2} )$$

and X_{corr}~C₁(X).
7. If Δ*+X_{nc}+X_{corr}, then accept the candidate (i.e., θⱼ₊₁=θ′), otherwise reject the candidate (i.e., θⱼ₊₁=θⱼ).

The normal variable X_{nc} is added to Δ* to produce a variable with unit variation. Steps 1 to 7 are repeated until θₜ has been added to the sequence.

Furthermore, the sampling method implemented by the sampling module 504 of FIG. 8 uses the logits (e.g., SoftMax outputs) of a number of the LLMs (e.g., the last LLM of the LLM-based system 502, the optimizer LLM and the evaluation LLM used to generate P) to compute the acceptance probability. Thus, to implement the described sampling method these LLMs are open-source LLMs. This clearly limits the applicability of the described method to only open-source LLMs. Accordingly, in some cases, steps 2 and 3 of the Metropolis Hastings algorithm are not performed, and instead all of the candidate sample parameters generated using TextGrad are used as the sample parameters. Such an amended method would not be strictly Bayesian, but would be a Bayesian estimator, however, it could be implemented with closed-source LLMs, such as, but not limited to ChatGPT.

In some cases, where there is no prior knowledge, P(θ), the feedback 819 may not be computed.

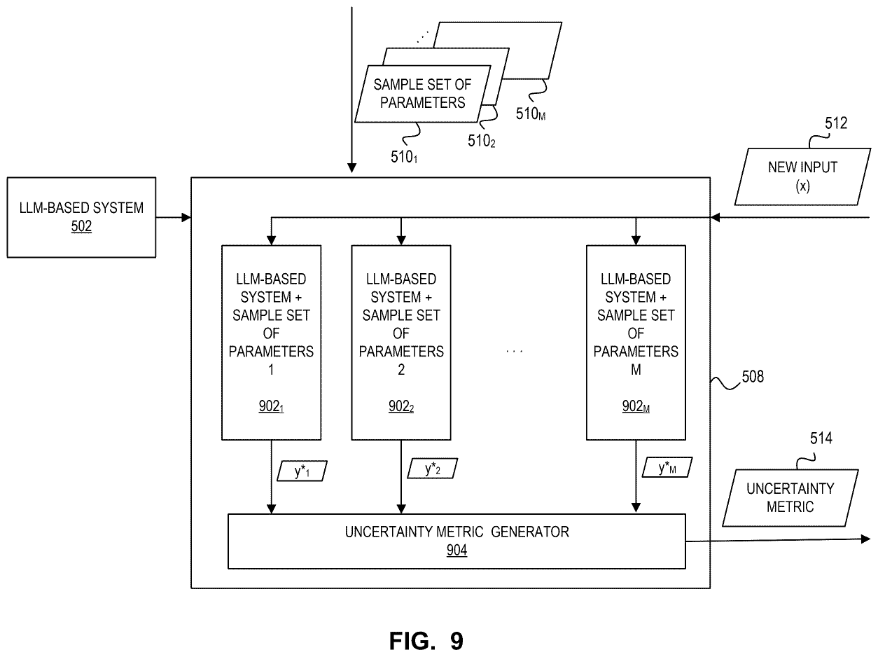

Reference is now made to FIG. 9 which illustrates an example implementation of the uncertainty generation module 506 of FIG. 5. In the example shown in FIG. 9, the uncertainty generation module 506 is configured to receive the LLM-based system 502 and the plurality of sample sets of the one or more textual parameters 510₁, 510₂, . . . , 510_{M} and is configured to generate a CLBS ensemble based thereon. Specifically, the uncertainty generation module 506 is configured to generate a version 902₁, 902₂, . . . , 902_{M} of the LLM-based system for each sample set of one or more textual parameters 510₁, 510₂, . . . , 510_{M}. In particular, each version 902₁, 902₂, . . . , 902_{M} of the LLM-based system is configured to use one of the sample sets of the one or more textual parameters. For example, if the LLM-based system 502 is the CLBS 200 of FIG. 2 and each sample set of parameters comprises an LLM prompt and a tool prompt, then each version 902₁, 902₂, . . . , 902_{M} of the LLM-based system is configured to use one set of LLM prompt and tool prompt.

The uncertainty generation module 506 is then configured to generate, from each version 902₁, 902₂, . . . , 902_{M} of the LLM-based system an output yᵢ* in response to a new input x 512.

The uncertainty generation module 506 is then configured to generate, using an uncertainty metric generator 904, an uncertainty metric 514 based on the diversity in the outputs

$${y}_{1}^{*} , {y}_{2}^{*} , … , {y}_{M}^{*} .$$

Any of the metrics described above, such as, but not limited, semantic entropy, claim scores for conformal factuality and ConU score may be used as the uncertainty metric.

### Example Methods

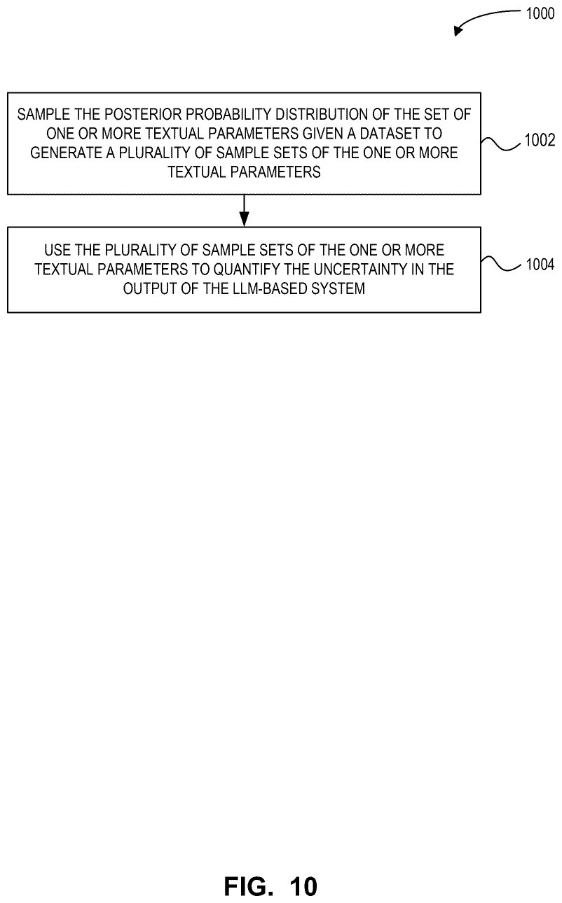

Reference is now made to FIG. 10 which illustrates an example method 1000 for quantifying the uncertainty in an LLM-based system output using Bayesian inference (e.g., performing Bayesian inference on a set of one or more textual parameters of the LLM-based system), which may be implemented, for example, by the cloud-based computing cluster 406 of FIG. 5. As described above, the LLM-based system is configured to receive an input and generate a textual output via one or more LLM calls. The LLM-based system comprises a set of one or more textual parameters θ.

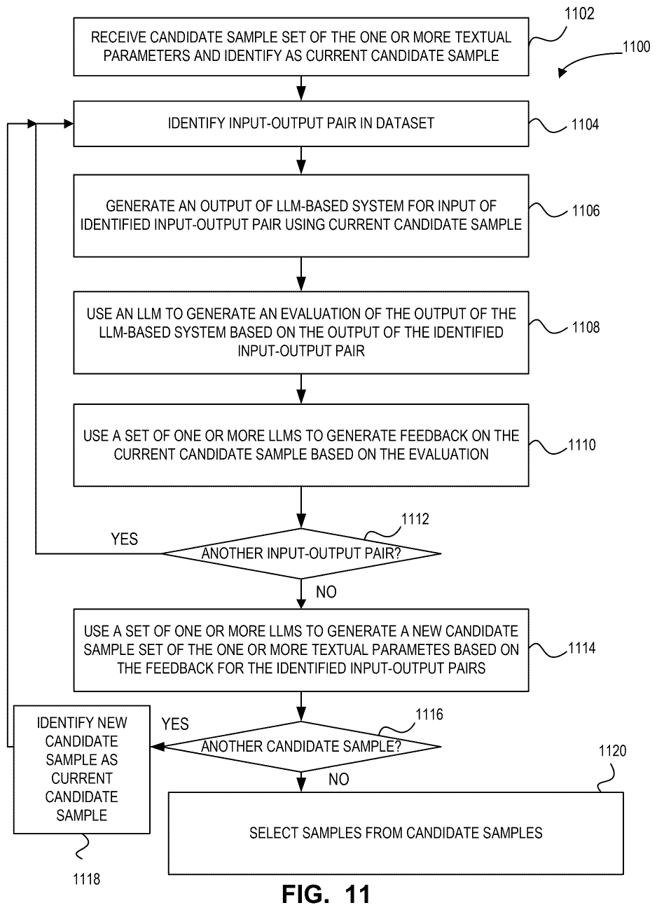

The method 1000 begins at block 1002 where the posterior probability distribution of the set of one or more textual parameters given a dataset D (i.e., p(θ|D)) is sampled to generate a plurality of sample sets of the one or more textual parameters. As described above, in some cases, the posterior probability distribution of the set of one or more textual parameters given the dataset (i.e., p(θ|D)) is sampled using the Metropolis Hastings algorithm (or a pseudo Metropolis Hastings algorithm) wherein TextGrad is used to implement the proposal distribution, q(θ′|θⱼ), of the Metropolis Hastings algorithm (i.e., q(θ′|θⱼ) is a TextGrad update to the set of one or more textual parameters, θ). An example method for sampling the posterior probability distribution of the set of one or more textual parameters given a dataset is described below with respect to FIG. 11. Once the plurality of sample sets of the one or more textual parameters has been generated, the method 1000 proceeds to block 1004.

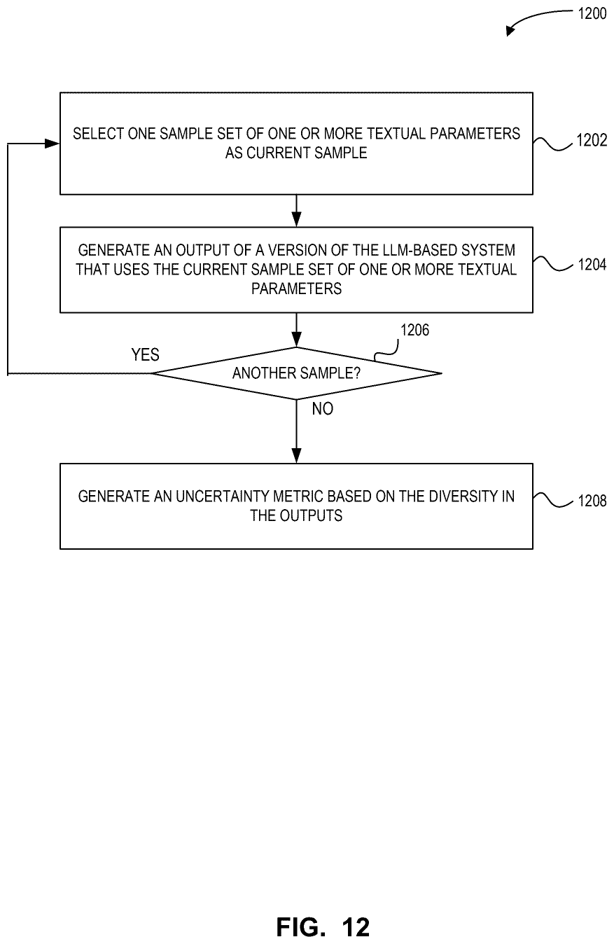

At block 1004, the plurality of sample sets of the one or more textual parameters are used to quantify the uncertainty in an output of the LLM-based system. As described above, in some cases, using the plurality of sample sets of textual parameters to determine the uncertainty in the output of the LLM-based system may comprise generating, for each sample set of textual parameters, an output of the LLM-based system using that sample set of textual parameters for an input, and determining the uncertainty in the output of the LLM-based system based on the variability in the outputs. An example method for quantifying the uncertainty in an LLM-based system's output in response to a new input based on a plurality of sample sets of the one or more textual parameters is described below with respect to FIG. 12.

Reference is now made to FIG. 11 which illustrates an example method 1100 for sampling the posterior probability distribution of the set of one or more textual parameters given a dataset (a set of input-output pairs) to generate a plurality of sample sets of the one or more textual parameters, which may be used to implement block 1002 of the method 1000 of FIG. 10. This example method samples the posterior probability distribution using the Metropolis Hastings algorithm (or a pseudo Metropolis Hastings algorithm) wherein TextGrad is used to implement the proposal distribution, q(θ′|θⱼ), of the Metropolis Hastings algorithm (i.e., q(θ′|θⱼ) is a TextGrad update to the set of one or more textual parameters, θ). In this example method it is assumed that the dataset comprises a plurality of input-output pairs.

The method begins at block 1102 where a candidate sample set of the one or more textual parameters is received and identified as the current candidate sample set of the one or more textual parameters. As described above, the candidate sample set of the one or more textual parameters comprises text for each of the one or more textual parameters. Once the candidate sample set of the one or more textual parameters is received and identified as the current candidate sample, the method 1100 proceeds to block 1104.

At block 1104, an input-output pair in the dataset is identified. Once an input-output pair in the dataset has been identified, the method 1100 proceeds to block 1106.

At block 1106, an output of the LLM-based system for the input in the identified input-output pair is generated using the current candidate sample set of one or more textual parameters. Once the output for the input of the identified input-output pair has been generated, the method 1100 proceeds to block 1108.

At block 1108, an LLM is used to generate an evaluation of the output of the LLM-based system based on the output in the identified input-output pair. The evaluation may indicate how well the output of the LLM-based system matches the output in the identified input-output pair. However, the evaluation may be used to assess any criteria. Examples of how the evaluation may be generated were provided above. Once the evaluation has been generated, the method 1100 proceeds to block 1110.

At block 1110, a set of one or more LLMs are used to generate (textual) feedback on the current candidate sample set of one or more textual parameters based on the evaluation. As described above, in some cases, this may be implemented by backpropagating the evaluation to the set of one or more textual parameters to effectively generate the gradient of the evaluation with respect to the set of one or more textual parameters. Examples of how this may be implemented were described above. Once the feedback on the set of one or more textual parameters based on the evaluation has been generated, the method 1100 proceeds to block 1112.

At block 1112, it is determined whether another input-output pair in the dataset is to be identified and blocks 1106-1110 repeated therefor. In some cases, another input-output pair is identified until all of the input-output pairs have been identified (i.e., until blocks 1106-1110 have been executed for each input-output pair in the dataset). In other cases, where for example mini-batches are used, another input-output pair may be identified until a predetermined number of input-pairs have been identified or until certain criteria have been met (see, for example, steps 1-7 of the mini-batch implementation of the Metropolis Hastings method described above). If it is determined that another input-pair in the dataset is to be identified, then the method 1100 proceeds back to block 1104 where another input-output pair in the dataset is identified and blocks 1106-1110 are executed for that input-output pair. If, however, it is determined that another input-output pair is not to be identified, then the method 1100 proceeds to block 1114.

At block 1114, a set of one or more LLMs is used to generate a new candidate sample set of the one or more textual parameters based on the feedback for the identified input-output pairs. Example methods for generating a new candidate sample set of the one or more textual parameters based on the feedback for the identified input-output pairs were described above. Once a new candidate sample set of the one or more textual parameters has been generated, the method 1100 proceeds to block 1116.

At block 1116, it is determined whether another candidate sample set of the one or more textual parameters is to be generated. In some cases, it may be determined that another candidate sample set of the one or more textual parameters is to be generated if there are less than a predetermined number, M, of candidate sample set of the one or more textual parameters. If it is determined that another candidate sample set of the one or more textual parameters is to be generated then the method 1100 proceeds to block 1118 where the new candidate sample set of the one or more textual parameters is identified as the current candidate sample and blocks 1104-1116 are executed for that new candidate sample. If, however, it is determined that another candidate sample set of the one or more textual parameters is not to be generated (e.g., because a sufficient number have been generated), then the method 1100 proceeds to block 1120.

At block 1120, a plurality of the candidate samples are selected as the samples. There are a variety of different methods which may be used to select the samples from the candidate samples. In some cases, where the method 1100 is a pseudo implementation of the Metropolis Hastings sampling method then all of the candidate samples may be used as the samples (e.g., steps 2-3 of the Metropolis Hastings method may not be performed). As described above, this allows the method 1100 to be implemented using closed-source LLMs. In other cases, where feedback on each candidate sample is generated for all of the input-output pairs in the dataset, then the candidate samples that are used as the samples may be selected in accordance with steps 2 and 3 of the Metropolis Hastings method described above (e.g., by computing an acceptance probability for each candidate (from the logits of one or more of the LLMs) and determining whether to use the candidate sample as a sample based on the acceptance probability). In other cases, where the feedback on each candidate sample is generated for a mini-batch of the input-output pairs in the dataset, then the candidate samples that are used as the samples may be selected in accordance with the Metropolis Hastings mini-batch method described above. Once the candidate samples which are to form the samples have been selected or identified, the method 1100 may end.

Although block 1120 is shown in FIG. 11 as being executed after blocks 1104-1116 have been completed, in other examples, the selection of samples from the candidate samples may be executed in parallel with blocks 1104-1116. For example, a determination may be made as to whether a candidate sample is to form part of the samples before all of the candidate samples have been generated.

Reference is now made to FIG. 12 which illustrates an example method 1200 for quantifying the uncertainty in an LLM-based system's output in response to a new input based on a plurality of sample sets of the one or more textual parameters, which may be used to implement block 1004 of the method 1000 of FIG. 10.

The method 1200 begins at block 1202 where one of the plurality sample sets of the one or more textual parameters is identified as the current sample. Once one of the plurality of samples has been identified as the current sample the method 1200 proceeds to block 1204.

At block 1204, an output is generated for an input from a version of the LLM-based system that uses the current sample set of the one or more textual parameters. Once the output for that version of the LLM-based system has been generated, the method 1200 proceeds to block 1206.

At block 1206, it is determined whether there is another sample set of one or more textual parameters. If there is another sample set of one or more textual parameters then the method 1200 proceeds back to blocks 1202 and 1204 where another sample is selected and an output for the input is generated from a version of the LLM-based system with that sample set of the one or more textual parameters. If, however, there is not another sample set of the one or more textual parameters, then the method 1200 proceeds to block 1208.

At block 1208 an uncertainty metric is generated based on the diversity in the outputs that indicates the uncertainty in the output. As described above, there are a number of different uncertainty metrics which could be used.

While in the example method 1200 of FIG. 12 the outputs for the different versions of the LLM-based system are generated consecutively (i.e., one after another), in other examples, the outputs of two or more of the versions of the LLM-based system may be generated in parallel.

### Example Computer

Reference is now made to FIG. 13 which illustrates a simplified block diagram of an example computer 1300. Computer 1300 is an example implementation of a computer which may implement the source database system 402, EDPP 404, one or more components of the cloud-based computing cluster 406 of FIGS. 4 and 5; and/or all or a portion of any of the methods 1000, 1100, 1200 of FIGS. 10-12. Computer 1300 has at least one processor 1302 operatively coupled to at least one memory 1304, at least one communications interface 1306 (also referred to herein as a network interface), and at least one input/output (I/O) device 1308.

The at least one memory 1304 includes a volatile memory that stores instructions executed or executable by the processor 1302, and input and output data used or generated during execution of the instructions. The memory 1304 may also include non-volatile memory used to store input and/or output data—e.g., within a database—along with program code containing executable instructions.

The processor 1302 may transmit or receive data via the communications interface 1306 and may also transmit or receive data via any additional input/output device 1308 as appropriate.

In some cases, the processor 1302 includes a system of central processing units (CPUs) 1310. In other cases, the processor 1302 includes a system of one or more CPUs 1310 and one or more Graphical Processing Units (GPUs) 1312 that are coupled together. For example, any combination of the LLMs described herein may execute neural network computations on CPU and GPU hardware, such as the system of CPUs 1310 and GPUs 1312 of FIG. 13.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g., a pushbutton keyboard, mouse, a touchscreen, and the like), and at least one output device (e.g., a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A computing system for quantifying uncertainty in a large language model (LLM)-based system that is configured to receive an input and generate an output via one or more LLM calls, the LLM-based system comprising a set of one or more textual parameters, the computing system comprising:
a memory, a communication interface, and at least one processor operatively coupled to the memory and the communication interface;
the at least one processor configured to:
sample from a posterior probability distribution of the set of one or more textual parameters given a dataset so as to generate a plurality of sample sets of the one or more textual parameters; and
use the plurality of sample sets of the one or more textual parameters to quantify uncertainty in an output of the LLM-based system.

2. The computing system of claim 1, wherein sampling from the posterior probability distribution of the set of one or more textual parameters given the dataset so as to generate the plurality of sample sets of the one or more textual parameters comprises:
generating a plurality of candidate sample sets of the one or more textual parameters by using a set of LLMs to iteratively evaluate a performance of the LLM-based system using a candidate sample set of the one or more textual parameters on the dataset, generate feedback on the set of one or more textual parameters based on the evaluation, and generate a new candidate sample set of the one or more textual parameters based on the feedback for use in a next iteration; and
selecting the plurality of sample sets from the candidate sample sets of the one or more textual parameters.

3. The computing system of claim 1, wherein the dataset comprises a plurality of input-output pairs, and sampling from the posterior probability distribution of the set of one or more textual parameters given the dataset comprises:
(a) receiving a candidate sample set of the one or more textual parameters and identifying the candidate sample set as a current candidate sample set;
(b) for each input-output pair of a set of input-output pairs of the dataset:
a. generating an output of the LLM-based system for the input in the input-output pair using the current candidate sample set,
b. using an LLM to generate an evaluation of the output of the LLM-based system based on the output in the input-output pair, and
c. using a set of one or more LLMs to generate, based on the evaluation, textual feedback on the current candidate sample set, and
(c) using a set of one or more LLMs to generate a new candidate sample set of the one or more textual parameters based on the textual feedback for the set of input-output pairs of the dataset;
(d) iteratively repeating (b) and (c), wherein the new candidate sample set in an iteration is identified as the current sample set for a subsequent iteration; and
(e) selecting the plurality of sample sets from the candidate sample sets of the one or more textual parameters.

4. The computing system of claim 3, wherein steps (a) to (e) implement a Metropolis Hastings sampling method.

5. The computing system of claim 4, wherein selecting the plurality of sample sets from the candidate sample sets of one or more textual parameters comprises generating, for each candidate sample set of one or more textual parameters, an acceptance probability and determining whether to select a candidate sample set as a sample set based on the acceptance probability for that candidate sample set.

6. The computing system of claim 5, wherein the LLM-based system comprises a final LLM that is configured to generate the LLM-based system output for the input in the input-output pair, and generating the acceptance probability for a candidate sample set of the one or more textual parameters comprises generating a likelihood for the output of the LLM-based system for the input in the input-output pair given the candidate sample set of the one or more textual parameters based on logits of the final LLM.

7. The computing system of claim 5, wherein generating the acceptance probability for a candidate sample set of the one or more textual parameters comprises generating a probability assigned to the candidate sample set of the one or more textual parameters based on a set of prior beliefs.

8. The computing system of claim 7, wherein generating the probability assigned to the candidate sample set of the one or more textual parameters based on the set of prior beliefs comprises instructing an LLM to evaluate the candidate sample set of the one or more textual parameters based on the set of prior beliefs and using logits of the LLM to determine the probability.

9. The computing system of claim 3, wherein sampling from the posterior probability distribution of the set of one or more textual parameters given the dataset further comprises:
using an LLM to generate a parameter evaluation of the current candidate sample set of the one or more textual parameters based on prior knowledge, and using a set of one or more LLMs to generate, based on the parameter evaluation, second textual feedback on the current candidate sample set of the one or more textual parameters;
wherein the new candidate sample set of the one or more textual parameters is generated based on the textual feedback for the set of input-output pairs of the dataset and the second textual feedback.

10. The computing system of claim 3, wherein the set of input-output pairs of the dataset comprises all of the input-output pairs in the dataset.

11. The computing system of claim 3, wherein the set of input-output pairs of the dataset comprises only a subset of the input-output pairs in the dataset.

12. The computing system of claim 3, wherein selecting the plurality of sample sets from the candidate sample sets of the one or more textual parameters comprises selecting all of the candidate sample sets as the sample sets.

13. The computing system of claim 3, wherein using the set of one or more LLMs to generate, based on the evaluation, textual feedback on the current candidate sample set comprises backpropagating the evaluation to the set of one or more textual parameters using the set of one or more LLMs to generate a textual gradient of the evaluation with respect to the current candidate sample set.

14. The computing system of claim 1, wherein at least one of the one or more textual parameters comprises a prompt used in an LLM call of the one or more LLM calls.

15. The computing system of claim 1, wherein the LLM-based system is a retrieval augmented generation system, and the one or more textual parameters comprises a system prompt used in an LLM call of the one or more LLM calls.

16. The computing system of claim 1, wherein using the plurality of sample sets of the one or more textual parameters to quantify the uncertainty in an output of the LLM-based system comprises:
for each of the plurality of sample sets of the one or more textual parameters, generating a different version of the LLM-based system that uses that sample set of the one or more textual parameters;
generating, for a same input, an output from each different version of the LLM-based system; and
generating an uncertainty metric based on a diversity in the outputs generated from the different versions of the LLM-based system.

17. A method for quantifying uncertainty in a large language model (LLM)-based system that is configured to receive an input and generate an output via one or more LLM calls, the LLM-based system comprising a set of one or more textual parameters, the method executed in a computing environment comprising at least one processor, a communication interface, and memory, and the method comprising:
sampling from a posterior probability distribution of the set of one or more textual parameters given a dataset so as to generate a plurality of sample sets of the one or more textual parameters; and
using the plurality of sample sets of the one or more textual parameters to quantify uncertainty in an output of the LLM-based system.

18. The method of claim 17, wherein sampling from the posterior probability distribution of the set of one or more textual parameters given the dataset so as to generate the plurality of sample sets of the one or more textual parameters comprises:
generating a plurality of candidate sample sets of the one or more textual parameters by using a set of LLMs to iteratively evaluate a performance of the LLM-based system using a candidate sample set of the one or more textual parameters on the dataset, generate feedback on the set of one or more textual parameters based on the evaluation, and generate a new candidate sample set of the one or more textual parameters based on the feedback for use in a next iteration; and
selecting the plurality of sample sets from the candidate sample sets of the one or more textual parameters.

19. The method of claim 17, wherein the dataset comprises a plurality of input-output pairs, and sampling from the posterior probability distribution of the set of one or more textual parameters given the dataset comprises:
(a) receiving a candidate sample set of the one or more textual parameters and identifying the candidate sample set as a current candidate sample set;
(b) for each input-output pair of a set of input-output pairs of the dataset:
a. generating an output of the LLM-based system for the input in the input-output pair using the current candidate sample set,
b. using an LLM to generate an evaluation of the output of the LLM-based system based on the output in the input-output pair, and
c. using a set of one or more LLMs to generate, based on the evaluation, textual feedback on the current candidate sample set, and
(c) using a set of one or more LLMs to generate a new candidate sample set of the one or more textual parameters based on the textual feedback for the set of input-output pairs of the dataset;
(d) iteratively repeating (b) and (c), wherein the new candidate sample set in an iteration is identified as the current sample set for a subsequent iteration; and
(e) selecting the plurality of sample sets from the candidate sample sets of the one or more textual parameters.

20. A non-transitory computer readable medium storing computer executable instructions which, when executed by at least one computer processor, cause the at least one computer processor to carry out a method for quantifying uncertainty in a large language model (LLM)-based system that is configured to receive an input and generate an output via one or more LLM calls, the LLM-based system comprising a set of one or more textual parameters, the method comprising:
sampling from a posterior probability distribution of the set of one or more textual parameters given a dataset so as to generate a plurality of sample sets of the one or more textual parameters; and
using the plurality of sample sets of the one or more textual parameters to quantify uncertainty in an output of the LLM-based system.
